(19) United States
(12) Patent Application Publication
(10) Pub. No.: US 2025/0147345 A1
(43) Pub. Date: May 8, 2025

(54) Low Non-Linear Loss Silicon Waveguides for Evanescent Couplers

(71) Applicant: Ayar Labs, Inc., San Jose, CA (US)

(72) Inventors: Hayk Gevorgyan, San Jose, CA (US); Derek Kita, Santa Clara, CA (US); Anatol Khilo, Dublin, CA (US); Derek Van Orden, San Francisco, CA (US); Neil Sapra, Berkeley, CA (US); Dries Vercruysse, Millbrae, CA (US); Milos Popovic, San Francisco, CA (US); John M. Fini, Albany, CA (US)

(21) Appl. No.: 19/014,193

(22) Filed: Jan. 8, 2025

Related U.S. Application Data
(63) Continuation-in-part of application No. 18/959,548, filed on Nov. 25, 2024.
Application No. 18/959,548 is a continuation of application No. 18/453,279, filed on Aug. 21, 2023, now Pat. No. 12,153,293.
Application No. 18/453,279 is a continuation of application No. 17/696,823, filed on Mar. 16, 2022, now Pat. No. 11,733,554.
(60) Provisional application No. 63/619,308, filed on Jan. 9, 2024.
(60) Provisional application No. 63/161,994, filed on Mar. 17, 2021.

(51) Int. Cl. G02F 1/025; G02B 6/02; G02B 6/12

(52) U.S. Cl. CPC G02F 1/025; G02B 6/02338; G02B 6/12; G02B 6/12004; G02B 2006/12123

(57) ABSTRACT

A first waveguide has a core region and a first side region extending laterally outward from a first side of the core region in a first direction perpendicular to a lengthwise centerline of the core region. A vertical thickness of the first side region is smaller than a vertical thickness of the core region. A second waveguide is positioned within an evanescent optical coupling distance of the core region of the first waveguide on a second side of the core region of the first waveguide opposite from the first side of the core region of the first waveguide. A diode is formed within the first side region of the first waveguide. The diode includes an n-doped region and a p-doped region that are physically separated from the core region of the first waveguide. An electrically conductive structure directly electrically connects with both the n-doped region and the p-doped region.

### CROSS-REFERENCE TO RELATED APPLICATIONS

This application claims priority under 35 U.S.C. 119 (e) to U.S. Provisional Patent Application No. 63/619,308, filed on Jan. 9, 2024, the disclosure of which is incorporated herein by reference in its entirety for all purposes.

This application is a continuation-in-part (CIP) under 35 U.S.C. 120 of prior U.S. patent application Ser. No. 18/959,548, filed on Nov. 25, 2024, which is a continuation application under 35 U.S.C. 120 of prior U.S. patent application Ser. No. 18/453,279, filed on Aug. 21, 2023, issued as U.S. Pat. No. 12,153,293, on Nov. 26, 2024, which is a continuation application under 35 U.S.C. 120 of prior U.S. patent application Ser. No. 17/696,823, filed on Mar. 16, 2022, issued as U.S. Pat. No. 11,733,554, on Aug. 22, 2023, which claims priority under 35 U.S.C. 119 (e) to U.S. Provisional Patent Application No. 63/161,994, filed on Mar. 17, 2021. The disclosure of each above-mentioned patent application is incorporated herein by reference in its entirety for all purposes.

### BACKGROUND OF THE INVENTION

Optical data communication systems operate by modulating laser light to encode digital data patterns within optical signals. The modulated laser light is transmitted through an optical data network from a sending node to a receiving node. The modulated laser light having arrived at the receiving node is de-modulated to obtain the original digital data patterns from the optical signals. The transmission of light through the optical data network includes transmission of light through optical fibers and transmission of light between optical fibers and photonic integrated circuits. In some embodiments, a photodiode is used to detect light of an optical data signal and convert the detected light into a photocurrent that can be processed through electrical circuitry to demodulate the optical data signal to obtain the original digital data pattern from the optical data signal. It is within this context that the present invention arises.

### SUMMARY OF THE INVENTION

In an example embodiment, an optical coupling configuration is disclosed. The optical coupling configuration includes a first waveguide that has a core region and a first side region. The first side region extends laterally outward from a first side of the core region in a first direction that is perpendicular to a lengthwise centerline of the core region. A vertical thickness of the first side region is smaller than a vertical thickness of the core region. The optical coupling configuration also includes a second waveguide that is positioned within an evanescent optical coupling distance of the core region of the first waveguide. The second waveguide is positioned on a second side of the core region of the first waveguide opposite from the first side of the core region of the first waveguide. The optical coupling configuration also includes a diode formed within the first side region of the first waveguide. The diode includes an n-doped region and a p-doped region. Both the n-doped region and the p-doped region are physically separated from the core region of the first waveguide. The optical coupling configuration also includes an electrically conductive structure in direct electrical connection with each of the n-doped region and the p-doped region, so as to form an electrical short between the n-doped region and the p-doped region.

In an example embodiment, an optical coupling configuration is disclosed. The optical coupling configuration includes a first waveguide that has a core region and a first side region. The first side region extends laterally outward from a first side of the core region in a first direction that is perpendicular to a lengthwise centerline of the core region. The first side region is formed as a meta-material. The optical coupling configuration also includes a second waveguide that is positioned within an evanescent optical coupling distance of the core region of the first waveguide. The second waveguide is positioned on a second side of the core region of the first waveguide opposite from the first side of the core region of the first waveguide. The optical coupling configuration also includes a diode formed within the first side region of the first waveguide. The diode includes an n-doped region and an p-doped region. Both the n-doped region and the p-doped region are physically separated from the core region of the first waveguide. The optical coupling configuration also includes an electrically conductive structure in direct electrical connection with each of the n-doped region and the p-doped region, so as to form an electrical short between the n-doped region and the p-doped region.

In an example embodiment, an optical coupling configuration is disclosed. The optical coupling configuration includes a first waveguide that has a core region and a first side region. The first side region extends laterally outward from a first side of the core region in a first direction that is perpendicular to a lengthwise centerline of the core region. A vertical thickness of the first side region is smaller than a vertical thickness of the core region. The optical coupling configuration also includes a second waveguide that is positioned within an evanescent optical coupling distance of the core region of the first waveguide. The second waveguide is positioned on a second side of the core region of the first waveguide opposite from the first side of the core region of the first waveguide. The optical coupling configuration also includes a doped region formed within the first side region of the first waveguide and through an optical coupling region between the core region of the first waveguide and the second waveguide. The doped region is physically separated from the core region of the first waveguide. The doped region has a dopant concentration sufficiently high to remove free-carriers from within the first waveguide within the optical coupling region.

### BRIEF DESCRIPTION OF THE DRAWINGS

FIG. 1 shows an optical coupling configuration, in accordance with some embodiments.

FIG. 2A shows a top view of an optical coupling configuration between a bus waveguide and a ring resonator, in accordance with some embodiments.

FIG. 2B shows a vertical cross-section through the optical coupling configuration, referenced as View A-A in FIG. 2A, in accordance with some embodiments.

FIG. 3A shows a top view of an optical coupling configuration between a bus waveguide and a coupling waveguide, in accordance with some embodiments.

FIG. 3B shows a vertical cross-section through the optical coupling configuration, referenced as View A-A in FIG. 3A, in accordance with some embodiments.

FIG. 4A shows a top view of an optical coupling configuration between a bus waveguide and a ring resonator, in accordance with some embodiments.

FIG. 4B shows a vertical cross-section through the optical coupling configuration, referenced as View A-A in FIG. 4A, in accordance with some embodiments.

FIG. 4C shows an optical coupling configuration between the bus waveguide and the ring resonator, in accordance with some embodiments.

FIG. 5 shows a top view of an optical coupling configuration between a bus waveguide and a ring resonator, in accordance with some embodiments.

FIG. 6A shows an example of a strip waveguide that is only doped along the edges of the strip waveguide, away from the peak optical power density of the waveguide mode, so as to reduce the linear FCA by the dopants, while capturing and recombining free-carriers as they diffuse to the sidewalls of the strip waveguide, in accordance with some embodiments.

FIG. 6B shows measurements comparing the optical transmission of the strip waveguide to a waveguide that is completely undoped, in accordance with some embodiments.

FIG. 7 shows an optical coupling configuration between a bus waveguide, a ring resonator, and a drop waveguide that implements the edge doping approach of FIG. 6A, in accordance with some embodiments.

FIG. 8A shows a vertical cross-section of an optical coupling region between a SiN bus waveguide and a silicon strip ring waveguide, where the SiN bus waveguide is positioned above the silicon strip ring waveguide in the material layer stack of the PIC chip, in accordance with some embodiments.

FIG. 8B shows a vertical cross-section of an optical coupling region between a SiN bus waveguide and a silicon half-rib ring waveguide, where the SiN bus waveguide is positioned above the silicon half-rib ring waveguide in the material layer stack of the PIC chip, in accordance with some embodiments.

FIG. 8C shows a vertical cross-section of an optical coupling region between a SiN bus waveguide and a silicon rib ring waveguide, where the SiN bus waveguide is positioned above the silicon rib ring waveguide in the material layer stack of the PIC chip, in accordance with some embodiments.

FIG. 8D shows a vertical cross-section of an optical coupling region between a SiN bus waveguide and a silicon strip ring waveguide, where the SiN bus waveguide is positioned below the silicon strip ring waveguide in the material layer stack of the PIC chip, in accordance with some embodiments.

FIG. 8E shows a vertical cross-section of an optical coupling region between a SIN bus waveguide and a silicon half-rib ring waveguide, where the SiN bus waveguide is positioned below the silicon half-rib ring waveguide in the material layer stack of the PIC chip, in accordance with some embodiments.

FIG. 8F shows a vertical cross-section of an optical coupling region between a SIN bus waveguide and a silicon rib ring waveguide, where the SiN bus waveguide is positioned below the silicon rib ring waveguide in the material layer stack of the PIC chip, in accordance with some embodiments.

FIG. 9 shows a top view of an optical coupling configuration between a SiN bus waveguide and a silicon ring waveguide, in accordance with some embodiments.

FIG. 10A shows a top view of an optical coupling configuration between a SiN bus waveguide and a silicon ring resonator, in accordance with some embodiments.

FIG. 10B shows a vertical cross-section of the optical coupling configuration through the optical coupling region, referenced as View A-A in FIG. 10A, in accordance with some embodiments.

FIG. 10C shows a vertical cross-section of the optical coupling configuration through the silicon ring resonator at a location away from optical coupling region, referenced as View B-B in FIG. 10A, in accordance with some embodiments.

FIG. 10D shows the optical coupling configuration with diode structures (encompassed by the dashed line) formed over the core region of the silicon ring resonator to provide for sweep-out of TPA-generated free-carriers from the core region and thereby mitigate/prevent optical loss caused by FCA, in accordance with some embodiments.

FIG. 10E shows a top view of an optical coupling configuration in which the silicon ring resonator has a full-rib waveguide geometry within the optical coupling region, in accordance with some embodiments.

FIG. 10F shows a top view of an optical coupling configuration in which the silicon ring resonator has a half-rib waveguide geometry within the optical coupling region, in accordance with some embodiments.

FIG. 10G shows a top view of an optical coupling configuration in which the silicon ring resonator has a strip-type waveguide geometry within the optical coupling region (similar to the optical coupling configuration of FIG. 10A), in accordance with some embodiments.

FIG. 11A shows the effective optical index versus device layer thickness for a silicon nitride (SiN) waveguide core having a thickness of 330 nanometers (nm) at 1300 nm operating light wavelength, in accordance with some embodiments.

FIG. 11B shows the effective optical index versus device layer thickness for a silicon nitride (SiN) waveguide core having a thickness of 400 nm at 1300 nm operating light wavelength, in accordance with some embodiments.

FIG. 11C shows the effective optical index versus device layer thickness for a silicon nitride (SiN) waveguide core having a thickness of 470 nm at 1300 nm operating light wavelength, in accordance with some embodiments.

FIG. 12A shows the effective optical index versus device layer thickness for a silicon waveguide core having a thickness of 220 nm at 1300 nm operating light wavelength, in accordance with some embodiments.

FIG. 12B shows the effective optical index versus device layer thickness for a silicon waveguide core having a thickness of 160 nm at 1300 nm operating light wavelength, in accordance with some embodiments.

FIG. 12C shows the effective optical index versus device layer thickness for a silicon waveguide core having a thickness of 100 nm at 1300 nm operating light wavelength, in accordance with some embodiments.

FIG. 12D shows the effective optical index versus device layer thickness for a silicon waveguide core having a thickness of 80 nm at 1300 nm operating light wavelength, in accordance with some embodiments.

FIG. 12E shows the effective optical index versus device layer thickness for a silicon waveguide core having a thickness of 50 nm at 1300 nm operating light wavelength, in accordance with some embodiments.

FIG. 13A shows symmetric and antisymmetric supermodes for a gap size of 500 nm between a SiN optical waveguide and a silicon optical waveguide within an optical coupling region having an optical coupling length of 20 micrometers, in accordance with some embodiments.

FIG. 13B shows symmetric and antisymmetric supermodes for a gap size of 700 nm between a SiN optical waveguide and a silicon optical waveguide within an optical coupling region having an optical coupling length of 57 micrometers, in accordance with some embodiments.

FIG. 13C shows symmetric and antisymmetric supermodes for a gap size of 900 nm between a SiN optical waveguide and a silicon optical waveguide within an optical coupling region having an optical coupling length of 137 micrometers, in accordance with some embodiments.

FIG. 14A shows a top view of an optical coupling configuration in which a silicon ring waveguide is optically coupled to a SiN bus waveguide, in accordance with some embodiments.

FIG. 14B shows a top view of an optical coupling configuration in which a silicon ring waveguide is optically coupled to a SiN bus waveguide, in accordance with some embodiments.

FIG. 14C shows a top view of an optical coupling configuration in which a silicon ring waveguide is optically coupled to a SiN bus waveguide, in accordance with some embodiments.

FIG. 14D shows a top view of an optical coupling configuration in which a silicon ring waveguide is optically coupled to a SiN bus waveguide within an optical coupling region, in accordance with some embodiments.

FIG. 15 shows a top view of an optical coupling configuration in which a silicon ring waveguide is optically coupled to a SiN bus waveguide within an optical coupling region, in accordance with some embodiments.

FIG. 16A shows a top view of an optical coupling configuration in which a ring waveguide is optically coupled to a bus waveguide within an optical coupling region, in accordance with some embodiments.

FIG. 16B shows a top view of an optical coupling configuration in which a ring waveguide is optically coupled to a bus waveguide within an optical coupling region, in accordance with some embodiments.

FIG. 16C shows a top view of an optical coupling configuration in which a ring waveguide is optically coupled to a bus waveguide within an optical coupling region, in accordance with some embodiments.

FIG. 17A shows a top view of an optical coupling configuration in which a ring waveguide is optically coupled to a bus waveguide within an optical coupling region, in accordance with some embodiments.

FIG. 17B shows a top view of an optical coupling configuration that is a variation of the optical coupling configuration of FIG. 17A, in accordance with some embodiments.

FIG. 17C shows a top view of an optical coupling configuration that is a variation of the optical coupling configuration of FIG. 17A, in accordance with some embodiments.

### DETAILED DESCRIPTION

In the following description, numerous specific details are set forth in order to provide an understanding of the embodiments disclosed herein. It will be apparent, however, to one skilled in the art that the embodiments disclosed herein may be practiced without some or all of these specific details. In other instances, well known process operations have not been described in detail in order not to unnecessarily obscure the disclosed embodiments.

Various embodiments are described herein for optical waveguide structures for optical coupling to other optical waveguide structures and/or ring resonator/modulator structures that reduces losses within the input light signal and/or within an associated optical bus waveguide, at high optical power due to two-photon absorption. The term “waveguide” as used herein refers to an optical waveguide structure through which light is guided. The term “ring resonator” as used herein refers to a circuitous (ring) shaped optical waveguide structure through which light is guided. The term “ring modulator” as used herein refers to a circuitous (ring) shaped optical waveguide structure through which light is guided and within which a light signal is modulated, such as to encode digital data within the modulated light signal. The term “bus waveguide” as used herein refers to an optical waveguide structure through which light is guided that is positioned next to (within an evanescent optical coupling distance of) another waveguide, such as a ring resonator or ring modulator. In some embodiments, the bus waveguide is configured to convey input light to a ring resonator/modulator and convey transmitted/modulated light away from the ring resonator/modulator. The term “drop waveguide” as used herein refers to an optical waveguide structure through which light is guided that is positioned next to (within an evanescent optical coupling distance of) another waveguide, such as a ring resonator or ring modulator. In some embodiments, the drop waveguide is configured to convey transmitted/modulated light away from a ring resonator/modulator.

Since the bandgap energy of silicon is larger than that of photons at telecom frequencies, optical (light) absorption loss within a silicon waveguide is typically negligible. However, the energy of two telecom/datacom-band photons does exceed the bandgap energy of silicon. When the energy of two photons within the silicon waveguide exceeds the bandgap energy of silicon, two-photon absorption (TPA) can occur within the silicon waveguide, thus incurring corresponding optical loss within the silicon waveguide. The likelihood of two photons being absorbed in the silicon waveguide increases quadratically with the intensity of light propagating though the silicon waveguide. Therefore, TPA in the silicon waveguide is a second order optical absorption effect that becomes more pronounced at higher optical power.

While TPA introduces an additional optical loss term, the absorption of the photons in TPA also frees charge carriers (electrons and holes) by promoting them from bound states in the valence band to the conduction band, which produces a carrier plasma that leads to further optical losses that are linear in optical intensity for a fixed plasma density. Because a substantial free-carrier density is produced by TPA, increased free-carrier density generation within the silicon waveguide can be an even more significant contributor to linear optical loss within the silicon waveguide at higher optical powers. The free-carriers (electrons and holes) generated within the silicon waveguide produce high free-carrier absorption (FCA) optical losses. The FCA optical loss is linear with the optical intensity for a given carrier density, with the free-carriers in turn being created by a second-order process, thus being a third-order effect. The optical absorption loss (dI/dz) in the silicon waveguide due to TPA and free-carrier optical absorption is represented in Equation 1, where (I) is the light intensity, (z) is the light propagation distance along the silicon waveguide, (α′) is the linear optical loss coefficient due to free-carriers within the silicon waveguide, (τ) is the free-carrier lifetime within the silicon waveguide, and (β′) is the TPA absorption coefficient.

$$( dI / dz ) = - {α}^{′} \cdot τ \cdot {β}^{′} {I}^{3} . \qquad Equation l$$

With regard to Equation 1, in order to reduce the third-order optical losses, the coefficient (α′·τ′β′) in front of the cubic term of intensity (I3) needs to be minimized. One way to do this is to reduce the free-carrier lifetime (τ). The free-carrier lifetime (τ) is determined by free-carrier diffusion and the free-carrier recombination rate. There is also a modified free-carrier recombination rate near waveguide boundaries, depending on the surface quality (roughness) and chemistry, which affects the free-carrier lifetime (τ), and is described by a surface recombination velocity coefficient. The free-carrier lifetime (τ) within the silicon waveguide is a key parameter, which can be reduced in various ways. For example, in some embodiments, the silicon waveguide fabrication is adjusted to increase the free-carrier recombination rate in silicon and/or at waveguide interfaces so as to correspondingly reduce the free-carrier lifetime (τ) within the silicon waveguide. In some embodiments, free-carriers are removed from the silicon waveguide by applying an electric field in the region of the silicon waveguide in which the free-carriers are generated. More specifically, an electric field is formed across a core region of the silicon waveguide. This electric field pulls the charged free-carriers (electrons and holes) away from the core region of the silicon waveguide through which the primary optical mode propagates, so that the probability of charged free-carriers causing optical absorption loss within the core region is substantially reduced. This process is known as carrier sweep out and can significantly reduce optical losses that scale with free-carrier concentration, such as the third-order optical absorption losses discussed above with regard to Equation 1. In some embodiments, in order to generate the electric field across the core region of the silicon waveguide for free-carrier sweep out, diodes are formed across/along the silicon waveguide and are operated in reverse bias mode.

It should be understood and appreciated that non-linear optical losses due to TPA and free-carrier absorption are relevant in many types and/or configurations of optical waveguides, including, but not limited to, bus waveguides, drop waveguides, ring resonators, ring modulators, and microring resonators/modulators (such as annular-shaped, disk-shaped, racetrack-shaped, and other similar circuitously shaped resonators/modulators), which are collectively referred to as traveling-wave resonators (TWRs). Also, it should be understood and appreciated that non-linear optical losses are relevant in many types and/or configurations of photonic crystals and other standing wave resonators (SWRs).

As discussed above, at high optical power, TPA within the silicon waveguide becomes more likely, which increases the probability of free-carrier generation within the silicon waveguide. The resulting free-carrier absorption within the silicon waveguide leads to high optical losses within the silicon waveguide. In many applications that require optical coupling from a bus waveguide to a ring resonator or other (e.g., output) waveguide, the optical power in the bus waveguide may be high enough that TPA is a serious problem. In optical data communication systems, a bus waveguide may carry many wavelengths of light, corresponding to different communication channels. The combination of these multiple wavelengths of light corresponds to a high optical power density within the bus waveguide. Therefore, it is of interest to improve optical data communication systems to mitigate the adverse optical losses caused by TPA and free-carrier absorption within silicon waveguides of various photonic components.

To this end, various waveguide embodiments are disclosed herein that include a rib waveguide and/or a half-rib waveguide, each doped on at least one side to create alternating interdigitated diode structures, so as to provide non-linear mitigation of optical losses due to TPA-generated free-carrier absorption in a region where the rib/half-rib waveguide couples to another waveguide and/or to a ring resonator/modulator. A built-in voltage of the alternating interdigitated diode structures produces an electric field over the waveguide core. This electric field sweeps free-carriers generated by TPA away from the optical mode within the waveguide and out to the electrodes of the diode structures. By operating the diode structures to remove the free-carriers, the free-carrier concentration in the waveguide core stays low, which minimizes optical losses due to free-carrier absorption and reduces the risk of damage at high optical powers. In some embodiments, an electrically conductive path is formed between the p-doped and n-doped regions of the diode structures on the side of the waveguide, which serves to prevent the build-up of TPA-generated free-carriers that would counteract the diode's built-in electric field. In some embodiments, the diode structures are constructed with minimal to no additional electrical interconnection. In particular, each diode structure does not require any metal traces that would need to be routed over the waveguide core in order to short the terminal contacts of the diode structure. However, in some embodiments, the diode structures utilize wires and/or metal traces that are routed from the terminal contacts of the diode structures to one or more power supplies in order to maintain reverse biasing of the diode structures. Also in some embodiments, the diode structures utilize wires and/or metal traces that are routed between the terminal contacts of the diode structures to provide a more reliable short circuit.

In some embodiments, a bus waveguide is positioned within an evanescent optical coupling distance of another waveguide, where the bus waveguide ha a rib waveguide configuration and the other waveguide has either a rib waveguide, a strip waveguide configuration, or a ring resonator/modulator configuration, or another configuration. In these embodiments, the rib waveguide configuration has a thick silicon core region, a first thinner silicon region on a first side of the core region, and a second thinner silicon region on a second side of the core region. In these embodiments, alternating interdigitated diode structures are formed on the first thinner silicon region of the bus waveguide, which is positioned on the side of the thick silicon core region that is farther away from the other waveguide to which the bus waveguide is optically coupled. In this manner, the alternating interdigitated diode structures are formed on the first thinner silicon region of the bus waveguide opposite from the optical coupling region between the bus waveguide and the other waveguide.

In some applications that require evanescent optical coupling from a bus waveguide having a rib waveguide configuration to a strip waveguide (where the strip waveguide has just a thick silicon core region) and/or to ring resonator/modulator, a transition waveguide is used to transform the bus waveguide from the rib waveguide configuration into the half-rib waveguide configuration, where the half-rib waveguide configuration has the thinner silicon region on just one side of the core region. This allows the core region of the bus waveguide to be close enough to the optical coupling region of the strip waveguide and/or ring resonator/modulator to enable sufficient optical coupling, while maintaining physical separation between the bus waveguide and the strip waveguide and/or ring resonator/modulator. In some embodiments, the transition waveguide has a tapering of the width of the thinner silicon region width on just one side of the core region, until the thinner silicon region disappears at the side of the core region next to the optical coupling region. In some embodiments, the tapering of the width of the thinner silicon region of the transition waveguide is configured such that a full thickness segment of the sidewall of the core region is present within the optical coupling region.

In some embodiments, some waveguide structures are not amenable to formation of diodes therein for free-carrier sweep out. In some embodiments, an alternative to using diodes for free-carrier sweep out from the core region of the waveguide is to dope the core region of the waveguide in order to create defects in the crystal structure of the silicon, in order to facilitate free-carrier recombination, and thereby shorten the free-carrier lifetime (τ) and correspondingly reduce the non-linear optical absorption within the core region of the waveguide, as expressed in Equation 1. Also, in some embodiments, a bus waveguide is formed of silicon nitride (SiN) which intrinsically avoids TPA due to the large bandgap of the silicon nitride material. Various implementations of these embodiments incorporate various tapering and refractive index configurations of the bus waveguide and/or ring resonator/modulator to enable efficient optical coupling between the bus waveguide and another waveguide having the strip waveguide configuration, the half-rib waveguide configuration, and/or the rib waveguide configuration, where the other waveguide has a horizontal cross-section that is a ring (annular) shape, a disc shape, a curve shape, a linear shape, and/or essentially any other shape.

Resonant integrated optical structures provide efficient devices for optical filters, optical modulators, and optical resonant photodiodes, as well as for quantum light generators (such as quantum correlated photon pair generation via non-linear optics). Microring and TWR resonators are coupled to and excited through a bus waveguide. In some embodiments that implement a bus-coupled ring or other resonator, non-linear optical loss is expected to be greater in the optical resonator when on-resonance than in the bus waveguide, when the optical resonator is excited by narrowband light within the resonance bandwidth of the optical resonator. However, there are also situations where the bus waveguide may see the dominant optical loss, such as when the light passing the resonator has a wavelength that is away from the cavity resonance wavelength of the resonator, and hence has higher intensity in the bus waveguide, or when the light is broadband (such as light emitting diode (LED) light, super-luminescent light emitting diode (SLED) light, amplified spontaneous emission light, supercontinuum light, or light having a plurality of narrowband (including single-frequency) channels, such as with a wavelength multiplexed optical comb source). Broadband light that has a much broader wavelength range as compared with the cavity resonant wavelength range of the optical resonator can have higher intensities in the bus waveguide than in the cavity of the optical resonator. Therefore, optical loss mitigation strategies are needed for optical resonator cavities, bus waveguides, and other waveguides in an optical circuit. It should be understood that it is not necessarily the case that optical resonator cavities will be the first affected by and/or the only ones that need a remedy for optical loss caused by TPA and FCA. Various embodiments are disclosed herein for mitigating non-linear optical loss in waveguide-to-waveguide optical coupling regions.

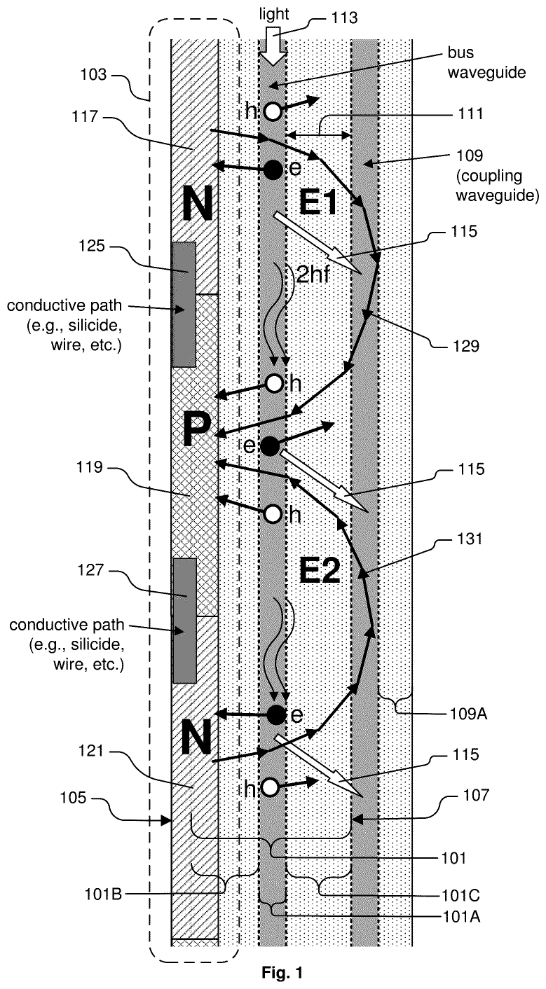

FIG. 1 shows an optical coupling configuration 100, in accordance with some embodiments. In the optical coupling configuration 100, a portion of a bus waveguide 101 implements diode structures 103 for free-carrier sweep out. The bus waveguide 101 is configured as a rib waveguide that has a core region 101A, a first side region 101B, and a second side region 101C. The core region 101A is formed to have a full thickness of a silicon layer within a photonic integrated circuit (PIC) chip. Each of the first side region 101B and the second side region 101C is formed to have less than the full thickness of the silicon layer. In some embodiments, each of the first side region 101B and the second side region 101C is a respective partially etched region of the silicon layer. FIG. 1 also shows a coupling waveguide 109 positioned within an evanescent optical coupling distance 111 of the bus waveguide 101. In this manner, FIG. 1 represents an optical coupling region between the bus waveguide 101 and the coupling waveguide 109, within which some of the light conveyed within the bus waveguide 101, as indicated by arrow 113, is coupled into the coupling waveguide 109, as indicated by arrows 115. In some embodiments, the coupling waveguide 109 is laterally bounded by the partially etched second side region 101C and by another partially etched side region 109A. In the example of FIG. 1, both the bus waveguide 101 and the coupling waveguide 109 have substantially linear shapes within the optical coupling region. Also, in the example of FIG. 1, the bus waveguide 101 and the coupling waveguide 109 are oriented substantially parallel with each other in the direction of light propagation, as indicated by arrow 113. However, it should be understood that in other embodiments, either the bus waveguide 101 and or the coupling waveguide 109 has a non-linear shape (e.g., curvilinear shape, ring shape, annular shape, disc shape, among others) within the optical coupling region, so long as at least a portion of the coupling waveguide 109 is positioned within an evanescent optical coupling distance of at least a portion of the bus waveguide 101.

The diode structures 103 are formed on one side of the bus waveguide 101 by an n-doped region 117, a p-doped region 119, and an n-doped region 121. In some embodiments, each of the n-doped region 117, the p-doped region 119, and the n-doped region 121 is formed within a respective portion of the first side region 101B of partially etched silicon along one side of the core region 101A of the bus waveguide 101. In some embodiments, the p-doped region 119 is formed to abut each of the n-doped region 117 and the n-doped region 121. The undoped silicon of the bus waveguide 101 functions as an intrinsic region adjacent to each of the n-doped region 117, the p-doped region 119, and the n-doped region 121. In this manner, a first P-I-N diode is formed by the p-doped region 119, the n-doped region 117, and the undoped silicon intrinsic region of the bus waveguide 101 next to each of the p-doped region 119 and the n-doped region 117. A built-in voltage of the first P-I-N diode produces a first intrinsic electric field E1 across the bus waveguide 101, and particularly across the core region 101A of the bus waveguide 101, as represented by the arrows 129. It should be understood that the core region 101 of the bus waveguide 101 is present in the intrinsic region of the first P-I-N diode where the first intrinsic electric field E1 is high. Similarly, a second P-I-N diode is formed by the p-doped region 119, the n-doped region 121, and the undoped silicon intrinsic region of the bus waveguide 101 next to each of the p-doped region 119 and the n-doped region 121. A built-in voltage of the second P-I-N diode produces a second intrinsic electric field E2 across the bus waveguide 101, and particularly across the core region 101A of the bus waveguide 101, as represented by the arrows 131. It should be understood that the core region 101 of the bus waveguide 101 is present in the intrinsic region of the second P-I-N diode where the second intrinsic electric field E2 is high. It should be understood that because the core region 101A of the bus waveguide 101 extends through the intrinsic regions of the first and second P-I-N diodes of the diode structures 103, the optical mode of the light that is conveyed within the core region 101A of the bus waveguide 101 does not substantially overlap with any of the doped regions of the diode structures 103, e.g., with any of the n-doped region 117, the p-doped region 119, and the n-doped region 121. Therefore, FCA that would be induced in the bus waveguide 101 by optical mode overlap with the doped regions of the diode structures 103 is minimized.

An electrically conductive structure 125 is formed in electrical connection with both the n-doped region 117 and the p-doped region 119. Also, an electrically conductive structure 127 is formed in electrical connection with both the n-doped region 121 and the p-doped region 119. The electrically conductive structure 125 electrically shorts the n-doped region 117 to the p-doped region 119 at the physical interface between the n-doped region 117 to the p-doped region 119 in order to prevent free-carrier build-up that would weaken the first electric field E1 of the first P-I-N diode. The electrically conductive structure 127 electrically shorts the n-doped region 121 to the p-doped region 119 at the physical interface between the n-doped region 121 to the p-doped region 119 in order to prevent free-carrier build-up that would weaken the second electric field E2 of the second P-I-N diode. In various embodiments, each of the electrically conductive structures 125 and 127 is formed as a respective wire, silicide region, metal structure, or other type of electrically conductive structure that can be fabricated within a semiconductor chip fabrication process.

It should be appreciated that the diode structures 103 are implemented on just one side of the bus waveguide 101 to provide for optical coupling of the bus waveguide 101 with the coupling waveguide 109 that is positioned on the opposite side of the bus waveguide 101 from the diode structures 103. The diode structures 103 and associated electrical contacts 117A, 119A, and 121A are positioned so as to not interfere with evanescent optical coupling between the bus waveguide 101 and the coupling waveguide 109. While the diode structures 103 in the example of FIG. 1 include two P-I-N diodes, it should be understood that in other embodiments, essentially any number of n-doped regions (cathode regions) and p-doped regions (anode regions) can be formed in an alternating positional manner along one side of the bus waveguide 101, so as to form essentially any number of P-I-N diodes along the one side of the bus waveguide 101. Also, a corresponding number of electrically conductive structures can be formed to electrically connect the n-doped region and the p-doped region of each of the P-I-N diodes along the one side of the bus waveguide 101, respectively.

FIG. 1 depicts how TPA-generated free-carriers (electrons (e) and holes (h)) are pulled/swept out of the core region 101A of the bus waveguide 101 by the diode structures 103. The first intrinsic electric field E1 generated by the first P-I-N diode pulls the free-carrier electrons (e) out of the core region 101A of the bus waveguide 101 toward the n-doped region 117, and pulls the free-carrier holes (h) out of the core region 101A of the bus waveguide 101 toward the p-doped region 119. The second intrinsic electric field E2 generated by the second P-I-N diode pulls the free-carrier electrons (e) out of the core region 101A of the bus waveguide 101 toward the n-doped region 121, and pulls the free-carrier holes (h) out of the core region 101A of the bus waveguide 101 toward the p-doped region 119. By electrically sweeping out the TPA-generated free-carriers from the core region 101A of the bus waveguide 101 before they cause FCA, the free-carrier concentration in the core region 101A remains low, which minimizes optical losses within the core region 101A due to FCA.

As depicted in FIG. 1, the built-in electric field of the diode structures 103 pushes free-carriers toward the electrodes (doped regions) of the diode structures 103 on the side of the bus waveguide 101 away from the core region 101A and away from the optical coupling region between the bus waveguide 101 and the coupling waveguide 109. Therefore, by having the diode structures 103 on one side of the bus waveguide 101, unidirectional free-carrier sweep out from the core region 101A of the bus waveguide 101 in the direction away from the coupling waveguide 109 is achieved, which provides for non-linear mitigation of TPA-generated FCA within the core region 101A of the bus waveguide 101 in support of optical coupling between the bus waveguide 101 and the coupling waveguide 109.

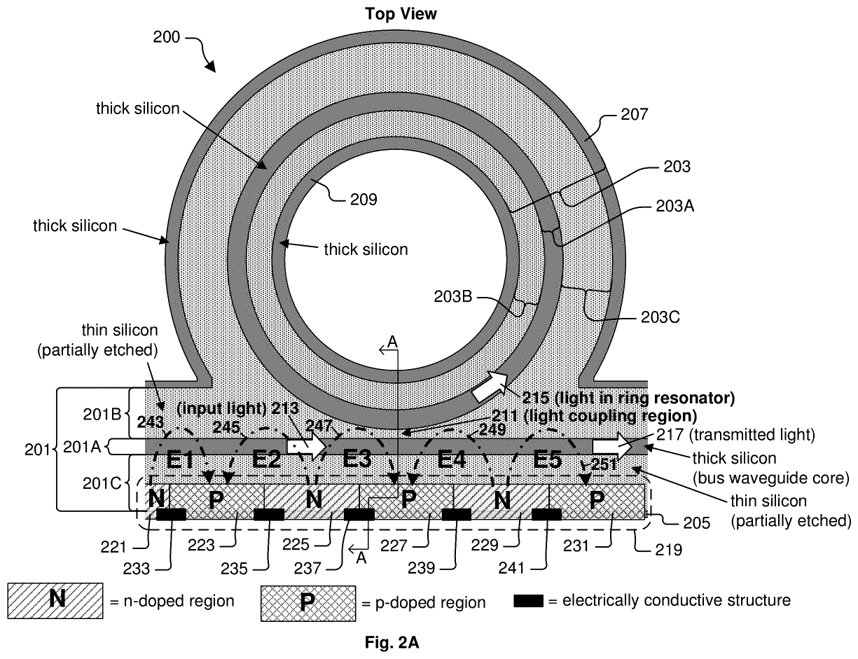

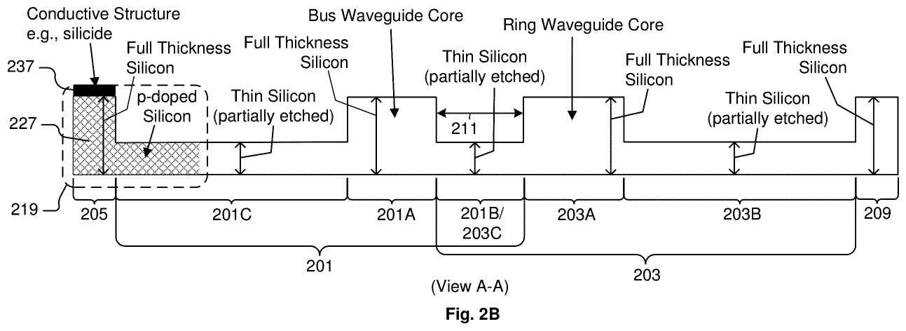

FIG. 2A shows a top view of an optical coupling configuration 200 between a bus waveguide 201 and a ring resonator 203, in accordance with some embodiments. The bus waveguide 201 is configured as a rib waveguide that has a core region 201A, a first side region 201B, and a second side region 201C. In some embodiments, the core region 201A is formed to have a full thickness of a silicon layer within a PIC chip. Each of the first side region 201B and the second side region 201C is formed to have less than the full thickness of the silicon layer. In some embodiments, each of the first side region 201B and the second side region 201C is a respective partially etched region of the silicon layer. The ring resonator 203 is configured as an annular-shaped rib waveguide that has a core region 203A, a inner side region 203B, and outer side region 203C. In some embodiments, the core region 203A is formed to have a full thickness of the silicon layer within the PIC chip, substantially similar to the full thickness of the core region 201A of the bus waveguide 201. Each of the inner side region 203B and the outer side region 203C is formed to have less than the full thickness of the silicon layer, substantially similar to the partially etched thickness of the first side region 201B and the second side region 201C of the bus waveguide 201. In some embodiments, each of the inner side region 203B and the outer side region 203C is a respective partially etched region of the silicon layer within the PIC chip. The first side region 201B of the bus waveguide 201 and the outer side region 203C of the ring resonator 203 are merged with each other within a region between the core region 201A of the bus waveguide 201 and the core region 203A of the ring resonator 203. In some embodiments, an outer frame region 205 is formed along the second side region 201C of the bus waveguide 201. Also, in some embodiments, an outer frame region 207 is formed along the outer side region 203C of the ring resonator 203. The outer frame region 207 also extends along the first side region 201B of the bus waveguide 201. Also, in some embodiments, an inner frame region 209 is formed along the inner side region 203B of the ring resonator 203. In some embodiments, each of the outer frame region 205, the outer frame region 207, and the inner frame region 209 has the full thickness of the silicon layer within the PIC chip, substantially similar to the full thickness of the core region 201A of the bus waveguide 201 and the full thickness of the core region 203A of the ring resonator 203.

The core region 203A of the ring resonator 203 is positioned within an evanescent optical coupling distance of the core region 201A of the bus waveguide 201, so as to form an optical (light) coupling region 211 between the core region 203A of the ring resonator 203 and the core region 201A of the bus waveguide 201. During operation, light is conveyed through the bus waveguide 201, as indicated by arrow 213. The primary optical mode of the light is conveyed within the core region 201A of the bus waveguide 201. At least a portion of the light is coupled from the bus waveguide 201 into the ring resonator 203, and especially into the core region 203A of the ring resonator 203, as indicated by arrow 215. The light that is coupled into the ring resonator 203 is guided through the core region 203A in a circuitous manner. In some embodiments, upon returning to the optical coupling region 211, at least some of the light within the ring resonator 203 optically couples back into the bus waveguide 201 as transmitted light, as indicated by arrow 217. Also, in some embodiments, some of the input light 213 within the bus waveguide 201 that approaches the ring resonator 203 does not couple into ring resonator 203 and becomes part of the transmitted light, as indicated by arrow 217. For example, in some embodiments, the ring resonator 203 is controlled (e.g., thermally controlled) to have a particular waveband of resonance wavelength. In this example, a portion of the input light 213 within the bus waveguide 201 that approaches the ring resonator 203 and that has a wavelength within the particular waveband of resonance wavelength of the ring resonator 203 will substantially optically couple from the bus waveguide 201 into the ring resonator 203. Also, in this example, a portion of the input light 213 within the bus waveguide 201 that approaches the ring resonator 203 and that does not have a wavelength within the particular waveband of resonance wavelength of the ring resonator 203 will not substantially optically couple from the bus waveguide 201 into the ring resonator 203.

The optical coupling configuration 200 between the bus waveguide 201 and the ring resonator 203 is equipped with diode structures 219 that produce electric fields E1 to E5 across the optical coupling region 211 between the bus waveguide 201 and the ring resonator 203 to provide for sweep-out of TPA-generated free-carriers within the core region 201A of the bus waveguide 201, so as to mitigate optical loss due to FCA within the optical coupling region 211. In the example of FIG. 2A, the diode structures 219 include an n-doped region 221, a p-doped region 223, an n-doped region 225, a p-doped region 227, an n-doped region 229, and a p-doped region 231. The n-doped regions 221, 225, 229 and the p-doped regions 223, 227, 231 are positioned in an alternating manner with regard to dopant type along the length of the bus waveguide 201, and particularly along the portion of the bus waveguide 201 that extends through the optical coupling region 211 between the bus waveguide 201 and the ring resonator 203.

The silicon of the bus waveguide 201 next to the n-doped regions 221, 225, 229 and the p-doped regions 223, 227, 231 provides the intrinsic material to form P-I-N diodes of the diode structures 219. In this manner, the n-doped region 221 and the p-doped region 223 form a first P-I-N diode that generates a first electric field E1 across the bus waveguide 201, as indicated by arrow 243. Also, the n-doped region 225 and the p-doped region 223 form a second P-I-N diode that generates a second electric field E2 across the bus waveguide 201, as indicated by arrow 245. Also, the n-doped region 225 and the p-doped region 227 form a third P-I-N diode that generates a third electric field E3 across the bus waveguide 201, as indicated by arrow 247. Also, the n-doped region 229 and the p-doped region 227 form a fourth P-I-N diode that generates a fourth electric field E4 across the bus waveguide 201, as indicated by arrow 249. Also, the n-doped region 229 and the p-doped region 231 form a fifth P-I-N diode that generates a fifth electric field E5 across the bus waveguide 201, as indicated by arrow 251.

Additionally, an electrically conductive structure 233 is formed to directly electrically connect the n-doped region 221 with the p-doped region 223 at the location where the n-doped region 221 and the p-doped region 223 physically contact each other. The electrically conductive structure 233 electrically shorts the n-doped region 221 to the p-doped region 223 in order to prevent free-carrier build-up that would weaken the first electric field E1 of the first P-I-N diode. Also, an electrically conductive structure 235 is formed to directly electrically connect the n-doped region 225 with the p-doped region 223 at the location where the n-doped region 225 and the p-doped region 223 physically contact each other. The electrically conductive structure 235 electrically shorts the n-doped region 225 to the p-doped region 223 in order to prevent free-carrier build-up that would weaken the second electric field E2 of the second P-I-N diode. Also, an electrically conductive structure 237 is formed to directly electrically connect the n-doped region 225 with the p-doped region 227 at the location where the n-doped region 225 and the p-doped region 227 physically contact each other. The electrically conductive structure 237 electrically shorts the n-doped region 225 to the p-doped region 227 in order to prevent free-carrier build-up that would weaken the third electric field E3 of the third P-I-N diode. Also, an electrically conductive structure 239 is formed to directly electrically connect the n-doped region 229 with the p-doped region 227 at the location where the n-doped region 229 and the p-doped region 227 physically contact each other. The electrically conductive structure 239 electrically shorts the n-doped region 229 to the p-doped region 227 in order to prevent free-carrier build-up that would weaken the fourth electric field E4 of the fourth P-I-N diode. Also, an electrically conductive structure 241 is formed to directly electrically connect the n-doped region 229 with the p-doped region 231 at the location where the n-doped region 229 and the p-doped region 231 physically contact each other. The electrically conductive structure 241 electrically shorts the n-doped region 229 to the p-doped region 231 in order to prevent free-carrier build-up that would weaken the fifth electric field E5 of the fifth P-I-N diode. In various embodiments, each of the electrically conductive structures 233, 235, 237, 239, 241 is formed as a respective wire, silicide region, metal structure, or other type of electrically conductive structure that can be fabricated within a semiconductor chip fabrication process.

It should be understood that the particular number of n-doped regions 221, 225, 229 and the p-doped regions 223, 227, 231 in the optical coupling configuration 200 is shown as an example to demonstrate unidirectional, one-sided free-carrier sweep out through the optical coupling region 211. In various other embodiments, essentially any number of alternatingly positioned n-doped regions and p-doped regions can be formed within the diode structures 219, along with formation of a corresponding number of electrically conductive structures to respectively electrically connect adjacently positioned ones of the n-doped regions and p-doped regions within the diode structures 219.

FIG. 2B shows a vertical cross-section through the optical coupling configuration 200, referenced as View A-A in FIG. 2A, in accordance with some embodiments. FIG. 2B shows the rib-shape of the bus waveguide 201 within the optical coupling region 211, and the rib-shape of the ring resonator 203. FIG. 2B also shows how the diode structures 219 are positioned laterally away from the core region 201A of the bus waveguide 201, and laterally away from the optical coupling region 211.

The functionality of the diode structures 219 with regard to free-carrier sweep-out from the bus waveguide 201, and especially from the core region 201A of the bus waveguide 201 is the same as described with regard to the diode structures 103 in the configuration of FIG. 1. Specifically, the electric fields E1 to E5 that are produced by the first through fifth P-I-N diodes of the diode structures 219 serve to push electrons toward the n-doped regions 221, 225, 229 and to push holes toward the p-doped regions 223, 227, 231. It should be understood that when the optical coupling region 211 includes both the incoming light 213 traveling along the bus waveguide 201 and some amount of light coupled from the ring resonator 203 back into the bus waveguide 201 to become transmitted light 217, the optical intensity within the optical coupling region 211 is increased and the probability of TPA is correspondingly increased. Therefore, having the diode structures 219 present along the optical coupling region 211 serves to substantially mitigate the increased probability of optical loss due to TPA and associated FCA. The diode structures 219 provide for non-linear mitigation of free-carriers that cause adverse optical absorption. It should be further appreciated that by having the diode structures 219 formed on just one side of the bus waveguide 201, the diode structures 219 do not interfere with positioning of the core region 203A (rib-shaped region) of the ring resonator 203 within the evanescent optical coupling distance of the core region 201A (rib-shaped region) of the bus waveguide 201. Also, it should be appreciated that by having the diode structures 219 formed on the side of the bus waveguide 201 opposite from the ring resonator 203, the materials of the n-doped regions 221, 225, 229 and the p-doped regions 223, 227, 231 and the electrically conductive structures 233, 235, 237, 239, 241 are collectively positioned away from the primary optical mode within the core region 201A of the bus waveguide 201, and away from the primary optical mode within the core region 203A of the ring resonator 203, and away from the optical coupling region 211 between the bus waveguide 201 and the ring resonator 203, so as to not cause adverse optical absorption.

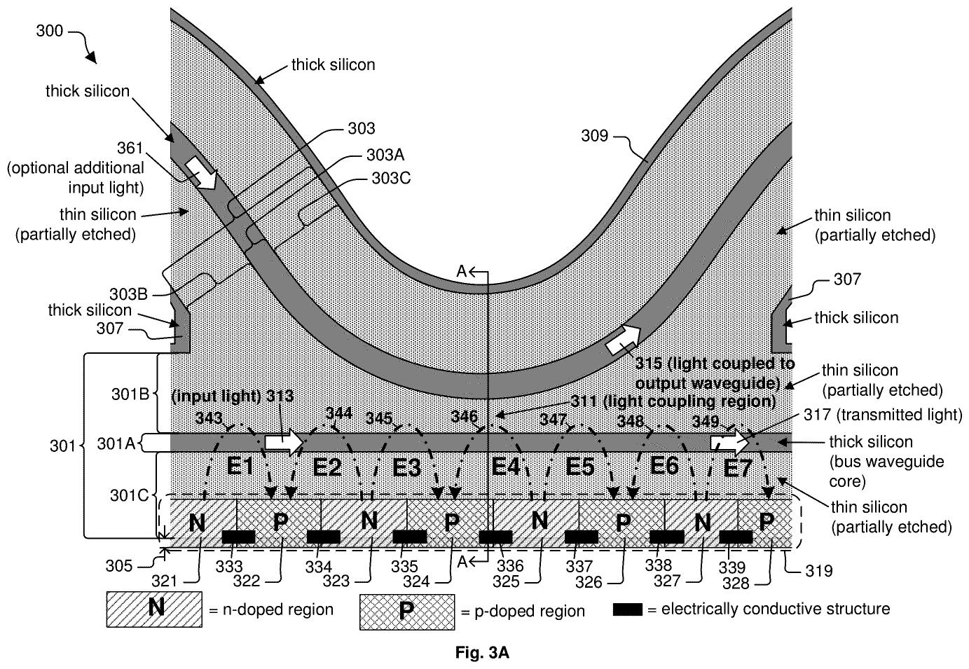

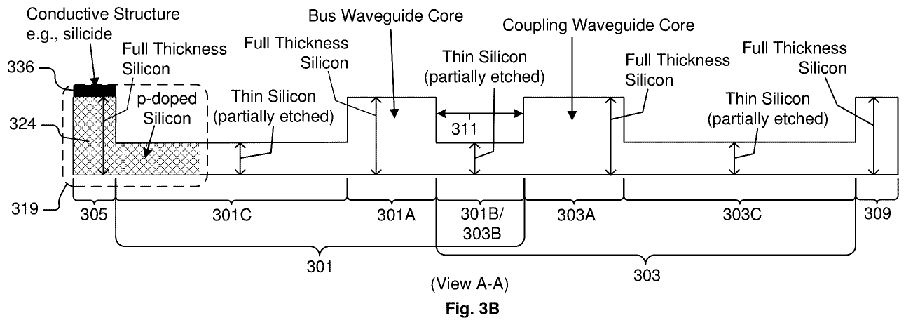

FIG. 3A shows a top view of an optical coupling configuration 300 between a bus waveguide 301 and a coupling waveguide 303, in accordance with some embodiments. The optical coupling configuration 300 represents a directional optical coupler. The bus waveguide 301 is configured as a rib waveguide that has a core region 301A, a first side region 301B, and a second side region 301C. In some embodiments, the core region 301A is formed to have a full thickness of a silicon layer within a PIC chip. Each of the first side region 301B and the second side region 301C is formed to have less than the full thickness of the silicon layer. In some embodiments, each of the first side region 301B and the second side region 301C is a respective partially etched region of the silicon layer. The coupling waveguide 303 is configured as a curvilinear-shaped rib waveguide that has a core region 303A, a first side region 303B, and second side region 303C. In some embodiments, the core region 303A is formed to have a full thickness of the silicon layer within the PIC chip, substantially similar to the full thickness of the core region 301A of the bus waveguide 301. Each of the first side region 303B and the second side region 303C is formed to have less than the full thickness of the silicon layer, substantially similar to the partially etched thickness of the first side region 301B and the second side region 301C of the bus waveguide 301. In some embodiments, each of the first side region 303B and the second side region 303C is a respective partially etched region of the silicon layer within the PIC chip. The first side region 301B of the bus waveguide 301 and the first side region 303B of the coupling waveguide 303 are merged with each other within a region between the core region 301A of the bus waveguide 301 and the core region 303A of the coupling waveguide 303. In some embodiments, an outer frame region 305 is formed along the second side region 301C of the bus waveguide 301. Also, in some embodiments, an outer frame region 307 is formed along the first side region 303B of the coupling waveguide 303. The outer frame region 307 also extends along the first side region 301B of the bus waveguide 301. Also, in some embodiments, an outer frame region 309 is formed along the second side region 303C of the coupling waveguide 303. In some embodiments, each of the outer frame region 305, the outer frame region 307, and the outer frame region 309 has the full thickness of the silicon layer within the PIC chip, substantially similar to the full thickness of the core region 301A of the bus waveguide 301 and the full thickness of the core region 303A of the coupling waveguide 303.

The core region 303A of the coupling waveguide 303 is positioned within an evanescent optical coupling distance of the core region 301A of the bus waveguide 301, so as to form an optical (light) coupling region 311 between the core region 303A of the coupling waveguide 303 and the core region 301A of the bus waveguide 301. During operation, light is conveyed through the bus waveguide 301, as indicated by arrow 313. The primary optical mode of the light is conveyed within the core region 301A of the bus waveguide 301. At least a portion of the light is coupled from the bus waveguide 301 into the coupling waveguide 303, and especially into the core region 303A of the coupling waveguide 303, as indicated by arrow 315. The light that is coupled into the coupling waveguide 303 is guided through the core region 303A along the lengthwise curvilinear path of the coupling waveguide 303. In some embodiments, additional input light is optionally conveyed along the coupling waveguide 303, as indicated by arrow 361. In some embodiments, at least some of the additional input light within the coupling waveguide 303 is optically coupled into the bus waveguide 301 as transmitted light, as indicated by arrow 317. Also, in some embodiments, some of the input light 313 within the bus waveguide 301 that approaches the optical coupling region 311 does not couple into coupling waveguide 303 and becomes part of the transmitted light, as indicated by arrow 317.

The optical coupling configuration 300 between the bus waveguide 301 and the coupling waveguide 303 is equipped with diode structures 319 that produce electric fields E1 to E7 across the optical coupling region 311 between the bus waveguide 301 and the coupling waveguide 303 to provide for sweep-out of TPA-generated free-carriers within the core region 301A of the bus waveguide 301, so as to mitigate optical loss due to FCA within the optical coupling region 311. In the example of FIG. 3A, the diode structures 319 include an n-doped region 321, a p-doped region 322, an n-doped region 323, a p-doped region 324, an n-doped region 325, a p-doped region 326, an n-doped region 327, and a p-doped region 328. The n-doped regions 321, 323, 325, 327 and the p-doped regions 322, 324, 326, 328 are positioned in an alternating manner with regard to dopant type along the length of the bus waveguide 301, and particularly along the portion of the bus waveguide 301 that extends through the optical coupling region 311 between the bus waveguide 301 and the coupling waveguide 303.

The silicon of the bus waveguide 301 next to the n-doped regions 321, 323, 325, 327 and the p-doped regions 322, 324, 326, 328 provides the intrinsic material to form P-I-N diodes of the diode structures 319. In this manner, the n-doped region 321 and the p-doped region 322 form a first P-I-N diode that generates a first electric field E1 across the bus waveguide 301, as indicated by arrow 343. Also, the n-doped region 323 and the p-doped region 322 form a second P-I-N diode that generates a second electric field E2 across the bus waveguide 301, as indicated by arrow 344. Also, the n-doped region 323 and the p-doped region 324 form a third P-I-N diode that generates a third electric field E3 across the bus waveguide 301, as indicated by arrow 345. Also, the n-doped region 325 and the p-doped region 324 form a fourth P-I-N diode that generates a fourth electric field E4 across the bus waveguide 301, as indicated by arrow 346. Also, the n-doped region 325 and the p-doped region 326 form a fifth P-I-N diode that generates a fifth electric field E5 across the bus waveguide 301, as indicated by arrow 347. Also, the n-doped region 327 and the p-doped region 326 form a sixth P-I-N diode that generates a sixth electric field E6 across the bus waveguide 301, as indicated by arrow 348. Also, the n-doped region 327 and the p-doped region 328 form a seventh P-I-N diode that generates a seventh electric field E7 across the bus waveguide 301, as indicated by arrow 349.

Additionally, an electrically conductive structure 333 is formed to directly electrically connect the n-doped region 321 with the p-doped region 322 at the location where the n-doped region 321 and the p-doped region 322 physically contact each other. The electrically conductive structure 333 electrically shorts the n-doped region 321 to the p-doped region 322 in order to prevent free-carrier build-up that would weaken the first electric field E1 of the first P-I-N diode. Also, an electrically conductive structure 334 is formed to directly electrically connect the n-doped region 323 with the p-doped region 322 at the location where the n-doped region 323 and the p-doped region 322 physically contact each other. The electrically conductive structure 334 electrically shorts the n-doped region 323 to the p-doped region 322 in order to prevent free-carrier build-up that would weaken the second electric field E2 of the second P-I-N diode. Also, an electrically conductive structure 335 is formed to directly electrically connect the n-doped region 323 with the p-doped region 324 at the location where the n-doped region 323 and the p-doped region 324 physically contact each other. The electrically conductive structure 335 electrically shorts the n-doped region 323 to the p-doped region 324 in order to prevent free-carrier build-up that would weaken the third electric field E3 of the third P-I-N diode. Also, an electrically conductive structure 336 is formed to directly electrically connect the n-doped region 325 with the p-doped region 324 at the location where the n-doped region 325 and the p-doped region 324 physically contact each other. The electrically conductive structure 336 electrically shorts the n-doped region 325 to the p-doped region 324 in order to prevent free-carrier build-up that would weaken the fourth electric field E4 of the fourth P-I-N diode. Also, an electrically conductive structure 337 is formed to directly electrically connect the n-doped region 325 with the p-doped region 326 at the location where the n-doped region 325 and the p-doped region 326 physically contact each other. The electrically conductive structure 337 electrically shorts the n-doped region 325 to the p-doped region 326 in order to prevent free-carrier build-up that would weaken the fifth electric field E5 of the fifth P-I-N diode. Also, an electrically conductive structure 338 is formed to directly electrically connect the n-doped region 327 with the p-doped region 326 at the location where the n-doped region 327 and the p-doped region 326 physically contact each other. The electrically conductive structure 338 electrically shorts the n-doped region 327 to the p-doped region 326 in order to prevent free-carrier build-up that would weaken the sixth electric field E6 of the sixth P-I-N diode. Also, an electrically conductive structure 339 is formed to directly electrically connect the n-doped region 327 with the p-doped region 328 at the location where the n-doped region 327 and the p-doped region 328 physically contact each other. The electrically conductive structure 339 electrically shorts the n-doped region 327 to the p-doped region 328 in order to prevent free-carrier build-up that would weaken the seventh electric field E7 of the seventh P-I-N diode. In various embodiments, each of the electrically conductive structures 333, 334, 335, 336, 337, 338, 339 is formed as a respective wire, silicide region, metal structure, or other type of electrically conductive structure that can be fabricated within a semiconductor chip fabrication process.

It should be understood that the particular number of n-doped regions 321, 323, 325, 327 and p-doped regions 322, 324, 326, 328 in the optical coupling configuration 300 is shown as an example to demonstrate unidirectional, one-sided free-carrier sweep out through the optical coupling region 311. In various other embodiments, essentially any number of alternatingly positioned n-doped regions and p-doped regions can be formed within the diode structures 319, along with formation of a corresponding number of electrically conductive structures to respectively electrically connect adjacently positioned ones of the n-doped regions and p-doped regions within the diode structures 319.

FIG. 3B shows a vertical cross-section through the optical coupling configuration 300, referenced as View A-A in FIG. 3A, in accordance with some embodiments. FIG. 3B shows the rib-shape of the bus waveguide 301 within the optical coupling region 311, and the rib-shape of the coupling waveguide 303. FIG. 3B also shows how the diode structures 319 are positioned laterally away from the core region 301A of the bus waveguide 301, and laterally away from the optical coupling region 311.

The functionality of the diode structures 319 with regard to free-carrier sweep-out from the bus waveguide 301, and especially from the core region 301A of the bus waveguide 301 is the same as described with regard to the diode structures 103 in the configuration of FIG. 1. Specifically, the electric fields E1 to E7 that are produced by the first through seventh P-I-N diodes of the diode structures 319 serve to push electrons toward the n-doped regions 321, 323, 325, 327 and to push holes toward the p-doped regions 322, 324, 326, 328. Having the diode structures 319 present along the optical coupling region 311 serves to substantially mitigate the optical loss due to TPA and associated FCA within the optical coupling region 311. The diode structures 319 provide for non-linear mitigation of free-carriers that cause adverse optical absorption. It should be further appreciated that by having the diode structures 319 formed on just one side of the bus waveguide 301, the diode structures 319 do not interfere with positioning of the core region 303A (rib-shaped region) of the coupling waveguide 303 within the evanescent optical coupling distance of the core region 301A (rib-shaped region) of the bus waveguide 301. Also, it should be appreciated that by having the diode structures 319 formed on the side of the bus waveguide 301 opposite from the coupling waveguide 303, the materials of the n-doped regions 321, 323, 325, 327 and the p-doped regions 322, 324, 326, 328 and the electrically conductive structures 333, 334, 335, 336, 337, 338, 339 are collectively positioned away from the primary optical mode within the core region 301A of the bus waveguide 301, and away from the primary optical mode within the core region 303A of the coupling waveguide 303, and away from the optical coupling region 311 between the bus waveguide 301 and the coupling waveguide 303, so as to not cause adverse optical absorption.

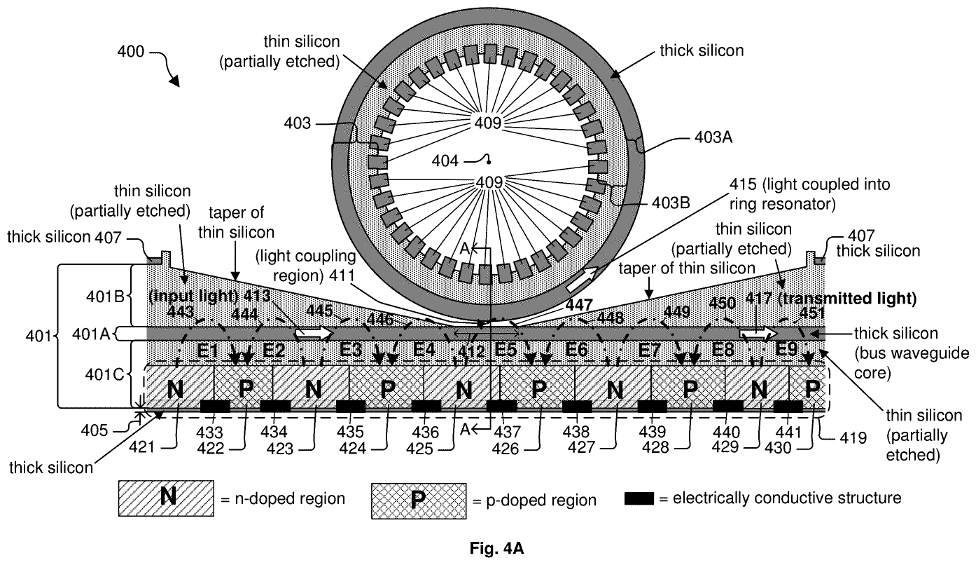

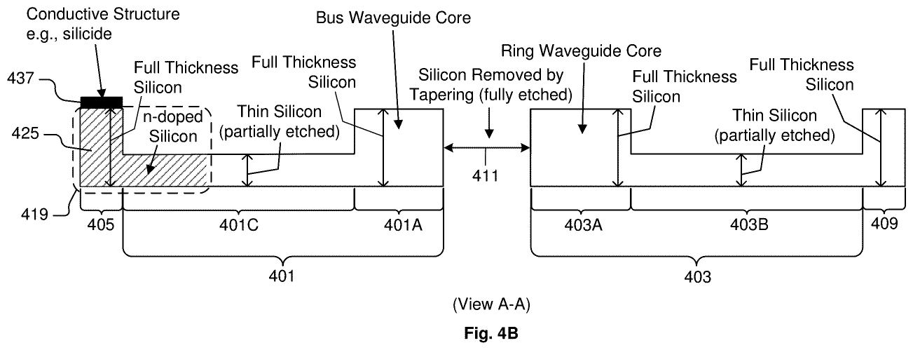

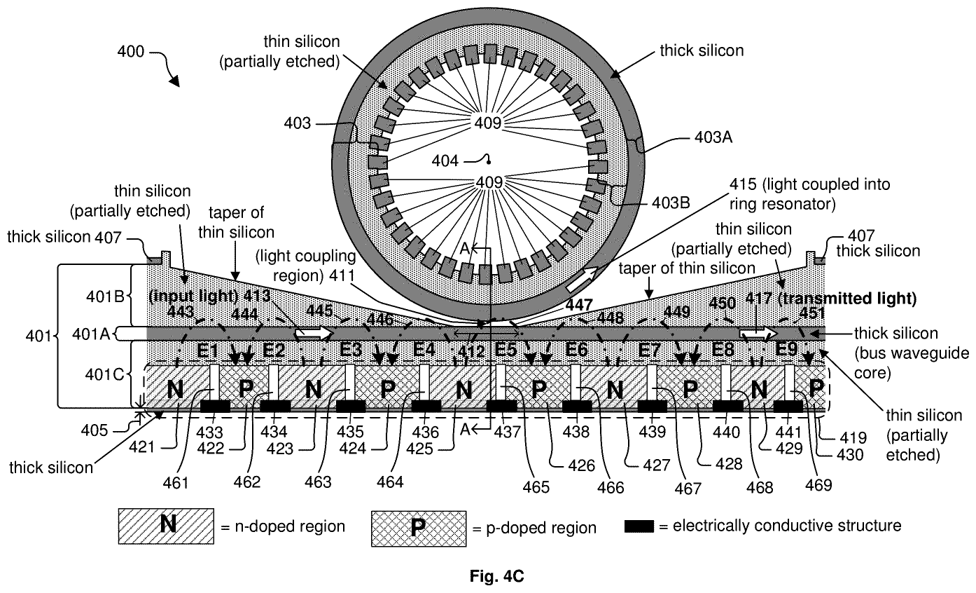

FIG. 4A shows a top view of an optical coupling configuration 400 between a bus waveguide 401 and a ring resonator 403, in accordance with some embodiments. The bus waveguide 401 is configured as a rib waveguide that has a core region 401A, a first side region 401B, and a second side region 401C. In some embodiments, the core region 401A is formed to have a full thickness of a silicon layer within a PIC chip. Each of the first side region 401B and the second side region 401C is formed to have less than the full thickness of the silicon layer. In some embodiments, each of the first side region 401B and the second side region 401C is a respective partially etched region of the silicon layer. The ring resonator 403 is configured as half-rib circuitous waveguide that has a core region 403A and an inner side region 403B. The core region 403A circles back into itself. In some embodiments, the core region 403A is formed to have a full thickness of the silicon layer within the PIC chip, substantially similar to the full thickness of the core region 401A of the bus waveguide 401. The inner side region 403B is formed to have less than the full thickness of the silicon layer, substantially similar to the partially etched thickness of the first side region 401B and the second side region 401C of the bus waveguide 401. In some embodiments, the inner side region 403B is a respective partially etched region of the silicon layer within the PIC chip.

A lateral width of the first side region 401B of the bus waveguide 401 is tapered down toward an optical coupling region 411 that exists between the core region 401A of the bus waveguide 301 and the core region 403A of the ring resonator 403. The tapering down of the lateral width of the first side region 401B of the bus waveguide 401 exists on each side of the optical coupling region 411 (on each side of the ring resonator 403. In some embodiments, the lateral width of the first side region 401B of the bus waveguide 401 is tapered down so that a segment 412 of a sidewall of the core region 401A of the bus waveguide 401 is exposed within the optical coupling region 411. In some embodiments, the tapering down of the lateral width of the first side region 401B of the bus waveguide 401 is substantially symmetric about a bisecting line that extends perpendicular to the lengthwise axis of the bus waveguide 401 and through a center-point 404 of the ring resonator 403. It should be understood and appreciated that the tapering down of the lateral width of the first side region 401B of the bus waveguide 401 provides for positioning of the core region 403A of the ring resonator 403 within an evanescent optical coupling distance of the core region 401A of the bus waveguide 401. In some embodiments, a tapered length of the portion of the bus waveguide 401 along which the first side region 401B of the bus waveguide 401 has the tapered lateral width is less than about micrometers. In some embodiments, the tapered length of the portion of the bus waveguide 401 is less than about 5 micrometers. Also, in some embodiments, the length of the segment 412 of exposed sidewall of the core region 401A of the bus waveguide 401 within the optical coupling region 411 is less than about 2 micrometers.

In some embodiments where a half-rib waveguide configuration of the bus waveguide 401 is needed within the optical coupling region 411, the bus waveguide 401 configuration starts with a full-rib waveguide configuration away from the optical coupling region 411, and tapers down the thin partially etched silicon of the first side region 401B of the bus waveguide 401 (on just one side of the bus waveguide 401) over some length of the bus waveguide 401 (on the order of a few micrometers long) sufficient to minimize scattering loss, until the bus waveguide 401 transitions into a half-rib waveguide configuration. The bus waveguide 401 of the optical coupling configuration 400 of FIG. 4A shows two such transitions, one going into the optical coupling region 411 in the direction of light propagation, and another going out of the optical coupling region 411 in the direction of light propagation.

In some embodiments, an outer frame region 405 is formed along the second side region 401C of the bus waveguide 401. Also, in some embodiments, an outer frame region 407 is formed along the full-width portions of the first side region 401B of the bus waveguide 401 that do not have the tapered lateral width. In some embodiments, each of the outer frame region 405 and the outer frame region 407 has the full thickness of the silicon layer within the PIC chip, substantially similar to the full thickness of the core region 401A of the bus waveguide 401 and the full thickness of the core region 403A of the ring resonator 403. Also, in some embodiments, a series of spirally oriented full thickness silicon segments 409 are formed in a spaced apart configuration along and over the inner edge of the inner side region 403B of the ring resonator 403. In some embodiments, the full thickness silicon segments 409 are used for electrical connection with the ring resonator 403. The inner positioning of the full thickness silicon segments 409 keeps the electrical connections with the ring resonator 403 away from the primary optical mode of the core region 403A of the ring resonator 403 in order to prevent optical absorption by the materials of the electrical connections.

The core region 403A of the ring resonator 403 is positioned within an evanescent optical coupling distance of the core region 401A of the bus waveguide 401, so as to form the optical (light) coupling region 411 between the core region 403A of the ring resonator 403 and the core region 401A of the bus waveguide 401. During operation, light is conveyed through the bus waveguide 401, as indicated by arrow 413. The primary optical mode of the light is conveyed within the core region 401A of the bus waveguide 401. At least a portion of the light is coupled from the bus waveguide 401 into the ring resonator 403, and especially into the core region 403A of the ring resonator 403, as indicated by arrow 415. The light that is coupled into the ring resonator 403 is guided through the core region 403A along the circuitous path of the ring resonator 403. In some embodiments, upon returning to the optical coupling region 411, at least some of the light within the ring resonator 403 optically couples back into the bus waveguide 401 as transmitted light, as indicated by arrow 417. Also, in some embodiments, some of the input light 413 within the bus waveguide 401 that approaches the ring resonator 403 does not couple into ring resonator 403 and becomes part of the transmitted light, as indicated by arrow 417. For example, in some embodiments, the ring resonator 403 is controlled (e.g., thermally controlled) to have a particular waveband of resonance wavelength. In this example, a portion of the input light 413 within the bus waveguide 401 that approaches the ring resonator 403 and that has a wavelength within the particular waveband of resonance wavelength of the ring resonator 403 will substantially optically couple from the bus waveguide 401 into the ring resonator 403. Also, in this example, a portion of the input light 413 within the bus waveguide 401 that approaches the ring resonator 403 and that does not have a wavelength within the particular waveband of resonance wavelength of the ring resonator 403 will not substantially optically couple from the bus waveguide 401 into the ring resonator 403.

The optical coupling configuration 400 between the bus waveguide 401 and the ring resonator 403 is equipped with diode structures 419 that produce electric fields E1 to E9 across the optical coupling region 411 between the bus waveguide 401 and the ring resonator 403 to provide for sweep-out of TPA-generated free-carriers within the core region 401A of the bus waveguide 401, so as to mitigate optical loss due to FCA within the optical coupling region 411. In the example of FIG. 4A, the diode structures 419 include an n-doped region 421, a p-doped region 422, an n-doped region 423, a p-doped region 424, an n-doped region 425, a p-doped region 426, an n-doped region 427, a p-doped region 428, an n-doped region 429, and a p-doped region 430. The n-doped regions 421, 423, 425, 427, 429 and the p-doped regions 422, 424, 426, 428, 430 are positioned in an alternating manner with regard to dopant type along the length of the bus waveguide 401, and particularly along the portion of the bus waveguide 401 that extends through the optical coupling region 411 between the bus waveguide 401 and the ring resonator 403.

The silicon of the bus waveguide 401 next to the n-doped regions 421, 423, 425, 427, 429 and the p-doped regions 422, 424, 426, 428, 430 provides the intrinsic material to form P-I-N diodes of the diode structures 419. In this manner, the n-doped region 421 and the p-doped region 422 form a first P-I-N diode that generates a first electric field E1 across the bus waveguide 401, as indicated by arrow 443. Also, the n-doped region 423 and the p-doped region 422 form a second P-I-N diode that generates a second electric field E2 across the bus waveguide 401, as indicated by arrow 444. Also, the n-doped region 423 and the p-doped region 424 form a third P-I-N diode that generates a third electric field E3 across the bus waveguide 401, as indicated by arrow 445. Also, the n-doped region 425 and the p-doped region 424 form a fourth P-I-N diode that generates a fourth electric field E4 across the bus waveguide 401, as indicated by arrow 446. Also, the n-doped region 425 and the p-doped region 426 form a fifth P-I-N diode that generates a fifth electric field E5 across the bus waveguide 401, as indicated by arrow 447. Also, the n-doped region 427 and the p-doped region 426 form a sixth P-I-N diode that generates a sixth electric field E6 across the bus waveguide 401, as indicated by arrow 448. Also, the n-doped region 427 and the p-doped region 428 form a seventh P-I-N diode that generates a seventh electric field E7 across the bus waveguide 401, as indicated by arrow 449. Also, the n-doped region 429 and the p-doped region 428 form an eighth P-I-N diode that generates an eighth electric field E8 across the bus waveguide 401, as indicated by arrow 450. Also, the n-doped region 429 and the p-doped region 430 form a ninth P-I-N diode that generates a ninth electric field E9 across the bus waveguide 401, as indicated by arrow 451.

Additionally, an electrically conductive structure 433 is formed to directly electrically connect the n-doped region 421 with the p-doped region 422 at the location where the n-doped region 421 and the p-doped region 422 physically contact each other. The electrically conductive structure 433 electrically shorts the n-doped region 421 to the p-doped region 422 in order to prevent free-carrier build-up that would weaken the first electric field E1 of the first P-I-N diode. Also, an electrically conductive structure 434 is formed to directly electrically connect the n-doped region 423 with the p-doped region 422 at the location where the n-doped region 423 and the p-doped region 422 physically contact each other. The electrically conductive structure 434 electrically shorts the n-doped region 423 to the p-doped region 422 in order to prevent free-carrier build-up that would weaken the second electric field E2 of the second P-I-N diode. Also, an electrically conductive structure 435 is formed to directly electrically connect the n-doped region 423 with the p-doped region 424 at the location where the n-doped region 423 and the p-doped region 424 physically contact each other. The electrically conductive structure 435 electrically shorts the n-doped region 423 to the p-doped region 424 in order to prevent free-carrier build-up that would weaken the third electric field E3 of the third P-I-N diode. Also, an electrically conductive structure 436 is formed to directly electrically connect the n-doped region 425 with the p-doped region 424 at the location where the n-doped region 425 and the p-doped region 424 physically contact each other. The electrically conductive structure 436 electrically shorts the n-doped region 425 to the p-doped region 424 in order to prevent free-carrier build-up that would weaken the fourth electric field E4 of the fourth P-I-N diode. Also, an electrically conductive structure 437 is formed to directly electrically connect the n-doped region 425 with the p-doped region 426 at the location where the n-doped region 425 and the p-doped region 426 physically contact each other. The electrically conductive structure 437 electrically shorts the n-doped region 425 to the p-doped region 426 in order to prevent free-carrier build-up that would weaken the fifth electric field E5 of the fifth P-I-N diode. Also, an electrically conductive structure 438 is formed to directly electrically connect the n-doped region 427 with the p-doped region 426 at the location where the n-doped region 427 and the p-doped region 426 physically contact each other. The electrically conductive structure 438 electrically shorts the n-doped region 427 to the p-doped region 426 in order to prevent free-carrier build-up that would weaken the sixth electric field E6 of the sixth P-I-N diode. Also, an electrically conductive structure 439 is formed to directly electrically connect the n-doped region 427 with the p-doped region 428 at the location where the n-doped region 427 and the p-doped region 428 physically contact each other. The electrically conductive structure 439 electrically shorts the n-doped region 427 to the p-doped region 428 in order to prevent free-carrier build-up that would weaken the seventh electric field E7 of the seventh P-I-N diode. Also, an electrically conductive structure 440 is formed to directly electrically connect the n-doped region 429 with the p-doped region 428 at the location where the n-doped region 429 and the p-doped region 428 physically contact each other. The electrically conductive structure 440 electrically shorts the n-doped region 429 to the p-doped region 428 in order to prevent free-carrier build-up that would weaken the eighth electric field E8 of the eighth P-I-N diode. Also, an electrically conductive structure 441 is formed to directly electrically connect the n-doped region 429 with the p-doped region 430 at the location where the n-doped region 429 and the p-doped region 430 physically contact each other. The electrically conductive structure 441 electrically shorts the n-doped region 429 to the p-doped region 430 in order to prevent free-carrier build-up that would weaken the ninth electric field E9 of the ninth P-I-N diode. In various embodiments, each of the electrically conductive structures 433, 434, 435, 436, 437, 438, 439, 440, 441 is formed as a respective wire, silicide region, metal structure, or other type of electrically conductive structure that can be fabricated within a semiconductor chip fabrication process.

It should be understood that the particular number of n-doped regions 421, 423, 425, 427, 429 and p-doped regions 422, 424, 426, 428, 430 in the optical coupling configuration 400 is shown as an example to demonstrate unidirectional, one-sided free-carrier sweep out through the optical coupling region 411. In various other embodiments, essentially any number of alternatingly positioned n-doped regions and p-doped regions can be formed within the diode structures 419, along with formation of a corresponding number of electrically conductive structures to respectively electrically connect adjacently positioned ones of the n-doped regions and p-doped regions within the diode structures 419.

FIG. 4B shows a vertical cross-section through the optical coupling configuration 400, referenced as View A-A in FIG. 4A, in accordance with some embodiments. FIG. 4B shows the half-rib-shape of the bus waveguide 401 within the optical coupling region 411, and the half-rib-shape of the ring resonator 403. FIG. 4B also shows how the diode structures 419 are positioned laterally away from the core region 401A of the bus waveguide 401, and laterally away from the optical coupling region 411.

The functionality of the diode structures 419 with regard to free-carrier sweep-out from the bus waveguide 401, and especially from the core region 401A of the bus waveguide 401 is the same as described with regard to the diode structures 103 in the configuration of FIG. 1. Specifically, the electric fields E1 to E9 that are produced by the first through ninth P-I-N diodes of the diode structures 419 serve to push electrons toward the n-doped regions 421, 423, 425, 427, 429 and to push holes toward the p-doped regions 422, 424, 426, 428, 430. Having the diode structures 419 present along the optical coupling region 411 serves to substantially mitigate the optical loss due to TPA and associated FCA within the optical coupling region 411. The diode structures 419 provide for non-linear mitigation of free-carriers that cause adverse optical absorption. It should be further appreciated that by having the diode structures 419 formed on just one side of the bus waveguide 401, the diode structures 419 do not interfere with positioning of the core region 403A (rib-shaped region) of the ring resonator 403 within the evanescent optical coupling distance of the core region 401A (rib-shaped region) of the bus waveguide 401. Also, it should be appreciated that by having the diode structures 419 formed on the side of the bus waveguide 401 opposite from the ring resonator 403, the materials of the n-doped regions 421, 423, 425, 427, 429 and the p-doped regions 422, 424, 426, 428, 430 and the electrically conductive structures 433, 434, 435, 436, 437, 438, 439, 440, 441 are collectively positioned away from the primary optical mode within the core region 401A of the bus waveguide 401, and away from the primary optical mode within the core region 403A of the ring resonator 403, and away from the optical coupling region 411 between the bus waveguide 401 and the ring resonator 403, so as to not cause adverse optical absorption.

FIG. 4C shows an optical coupling configuration 460 between the bus waveguide 401 and the ring resonator 403, in accordance with some embodiments. The optical coupling configuration 460 of FIG. 4C is a variation of the optical coupling configuration 400 of FIGS. 4A and 4B. Like structures identified by like reference numerals in FIG. 4C are the same as described above with regard to FIGS. 4A and 4B. The variation between the optical coupling configuration 460 and the optical coupling configuration 400 of FIG. 4A concerns the interfaces between the n-doped regions 421, 423, 425, 427, 429 and the p-doped regions 422, 424, 426, 428, 430 of the diode structures 419. Specifically, rather than having the p-doped region and the n-doped region of each of the diode structures 419 be in physical contact with each other, the optical coupling configuration 460 implements full thickness non-conductive regions 461, 462, 463, 464, 465, 467, 468, 469 to prevent direct p-n junction formation between the p-doped region and the n-doped region of each of the diode structures 419. In some embodiments, each of the full thickness non-conductive regions 461, 462, 463, 464, 465, 467, 468, 469 is a formed as a respective oxide spacer that physically and electrically separates the adjacent p-doped region from the adjacent n-doped region. In some embodiments, each of the full thickness non-conductive regions 461, 462, 463, 464, 465, 467, 468, 469 is a formed as a respective hole that is etched at the boundary between the adjacently positioned p-doped region and n-doped region, such that the respective hole extends laterally from the intrinsic (I) region on one side the particular diode to the respective electrically conductive structure 433, 434, 435, 436, 437, 438, 439, 440, 441 on the other side of the particular diode. In some embodiments, the each of the full thickness non-conductive regions 461, 462, 463, 464, 465, 467, 468, 469 is a formed as a respective hole that is filled with an insulator material, such as oxide, e.g., shallow-trench isolation (STI) oxide. Filling of the full thickness non-conductive regions 461, 462, 463, 464, 465, 467, 468, 469 with the insulator material prevents formation of a parasitic p-n junction between adjacently positioned p-doped region and n-doped region, which could electrically compete with the sweep-out of the free-carriers from the bus waveguide 401 by the electric field of the corresponding P-I-N diode. It should be appreciated that formation of the full thickness non-conductive regions 461, 462, 463, 464, 465, 467, 468, 469 is done through standard semiconductor chip fabrication processes.

The fully etched non-conductive region 461 blocks formation of a p-n junction between the p-doped region 422 and the n-doped region 421 of the first P-I-N diode. Direct electrical connection of the p-doped region 422 and the n-doped region 421 is provided by the electrically conductive structure 433. The fully etched non-conductive region 462 blocks formation of a p-n junction between the p-doped region 422 and the n-doped region 423 of the second P-I-N diode. Direct electrical connection of the p-doped region 422 and the n-doped region 423 is provided by the electrically conductive structure 434. The fully etched non-conductive region 463 blocks formation of a p-n junction between the p-doped region 424 and the n-doped region 423 of the third P-I-N diode. Direct electrical connection of the p-doped region 424 and the n-doped region 423 is provided by the electrically conductive structure 435. The fully etched non-conductive region 464 blocks formation of a p-n junction between the p-doped region 424 and the n-doped region 425 of the fourth P-I-N diode. Direct electrical connection of the p-doped region 424 and the n-doped region 425 is provided by the electrically conductive structure 436. The fully etched non-conductive region 465 blocks formation of a p-n junction between the p-doped region 426 and the n-doped region 425 of the fifth P-I-N diode. Direct electrical connection of the p-doped region 426 and the n-doped region 425 is provided by the electrically conductive structure 437. The fully etched non-conductive region 466 blocks formation of a p-n junction between the p-doped region 426 and the n-doped region 427 of the sixth P-I-N diode. Direct electrical connection of the p-doped region 426 and the n-doped region 427 is provided by the electrically conductive structure 438. The fully etched non-conductive region 467 blocks formation of a p-n junction between the p-doped region 428 and the n-doped region 427 of the seventh P-I-N diode. Direct electrical connection of the p-doped region 428 and the n-doped region 427 is provided by the electrically conductive structure 439. The fully etched non-conductive region 468 blocks formation of a p-n junction between the p-doped region 428 and the n-doped region 429 of the eighth P-I-N diode. Direct electrical connection of the p-doped region 428 and the n-doped region 429 is provided by the electrically conductive structure 440. The fully etched non-conductive region 469 blocks formation of a p-n junction between the p-doped region 430 and the n-doped region 429 of the ninth P-I-N diode. Direct electrical connection of the p-doped region 430 and the n-doped region 429 is provided by the electrically conductive structure 441.

In some embodiments, the silicon diode structures 103, 219, 319, 419 are physically connected to the core regions 101A, 201A, 301A, 401A, respectively, of the silicon bus waveguides 101, 201, 301, 401, respectively, by a thin region of silicon that is thinner than the core regions 101A, 201A, 301A, 401A, respectively, of the silicon bus waveguides 101, 201, 301, 401, respectively. In some embodiments, this thin region of silicon is manufactured by a partial etching process that is applied in prescribed regions of a thicker silicon layer. In this manner, in some embodiments, the bus waveguides 101, 201, 301, 401 are formed as a rib-shaped waveguides that have thin (partially etched) silicon regions on both sides of the core region 101A, 201A, 301A, 401A, respectively. Also, in some embodiments, the bus waveguide 401 is formed or as a half-rib-shaped waveguide that has a thin (partially etched) silicon region on only one side of the core region 401A along a portion of the length of the bus waveguide 401. This embodiment is particularly applicable where optical coupling is needed between the core region 401A of the bus waveguide 401 and either a strip waveguide, a half-rib-shaped waveguide, or a ring resonator that has a strip waveguide and/or a half-rib-shaped waveguide. In some embodiments, a waveguide structure (rib-shaped, half-rib-shaped) and/or ring resonator structure is formed by using two independently patterned layers of core region material, such as transistor body crystalline silicon (c-Si) and gate poly-crystalline silicon (p-Si) that is available in many CMOS transistor platforms (as one example IBM 12SOI and GlobalFoundries 45RFSOI SOI CMOS), where the c-Si layer forms a slab, and where the polysilicon gate layer is patterned to form the “cap” of the rib portion (e.g., core region 101A, 201A, 301A, 401A) of the waveguide. It should be understood that the various optical coupling configuration embodiments disclosed herein can have their bus waveguide, coupling waveguides, ring resonators, and other structures formed by standard semiconductor fabrication processes, such as photolithography, material deposition (chemical vapor deposition and/or spin-on deposition), material etching (chemical and/or plasma), and/or essentially any other known and applicable semiconductor fabrication process.

Generally speaking, in some optical coupling configuration embodiments, the bus waveguide is coupled to another waveguide, or to a resonator structure, such as a ring resonator, that has a waveguide that circles back and connects to itself. In some of these embodiments, such as found in optical data communication systems, the ring resonator is a ring filter that selectively routes a single wavelength or communication channel from the bus waveguide to a drop waveguide, and then to a photodetector for optical signal detection. In some embodiments, the ring resonator is a ring modulator with a separate built-in diode in the ring region that selectively encodes data from a voltage signal into a single wavelength optical signal or channel in the bus waveguide. In some embodiments, the optical power that is coupled from the bus waveguide to the drop waveguide or to the ring resonator is sufficiently high that non-linear mitigation is implemented in the drop waveguide or ring resonator as well as the bus waveguide. Therefore, in some embodiments, the drop waveguide or the ring resonator also has built-in diodes with interdigitated alternating dopants and shorted contacts for free-carrier sweep out, similar to diode structures 103 formed within the bus waveguide 101, and/or similar to diode structures 219 formed within the bus waveguide 201, and/or similar to the diode structure 319 formed within the bus waveguide 301, and/or similar to the diode structures 419 formed within the bus waveguide 401.

As discussed with regard to the diode structures 103, 219, 319, 419 of the optical coupling configurations 100, 200, 300, 400, respectively, the diodes within each of the diode structures 103, 219, 319, 419 are electrically shorted to each other by an electrically conductive structure (such as a metal structure, a wire, silicide, or another form of electrical connection) in order to prevent free-carrier build-up that would weaken the built-in electric field of the diodes. In some embodiments, the diodes within the diode structures 103, 219, 319, 419 of the optical coupling configurations 100, 200, 300, 400, respectively, are electrically connected to a power supply or to another voltage control device in order to ensure that the diodes operate in reverse bias. This option for connection of the diodes to the power supply or to another voltage control device to ensure reverse bias operation applies to all diode structures disclosed herein. In some embodiments, a silicide region is formed to extend contiguously along the full length of the diode structures 103, 219, 319, 419, so as to extend over, physically connect to, and electrically connect to each of the n-doped regions and p-doped regions within the diode structures 103, 219, 319, 419, without interruption. In some embodiments, the silicide region is formed to cover the entire width (along the length direction of the bus waveguide) of the n-doped region and p-doped regions of the diode structures 103, 219, 319, 419, so that the electrically conductive path provided by the silicide extends continuously along the bus waveguide rather than being intermittently positioned along the bus waveguide.

In some situations, formation of a built-in P-I-N diode within a waveguide is challenging if the waveguide does not have a thinner slab region on either side of a thicker core region, such that the thinner slab region can be doped to form an n-doped region and a p-doped region, and such that the thinner slab region can be electrically contacted in order to form a diode. In some embodiments, in order to facilitate diode formation, the thinner slab region is replaced with a metamaterial, where the metamaterial has alternating regions of full thickness silicon and fully etched silicon that forms an effective medium of lower optical index when the full thickness silicon regions and the fully etched regions alternate with a small enough period (below the effective wavelength of the guided optical mode as defined by the light propagation constant). In these embodiments that implement the metamaterial in lieu of the thinner slab region of silicon in order to form the built-in diode along the bus waveguide, a sub-wavelength cladding on either side of the core region of the bus waveguide supports optical confinement.

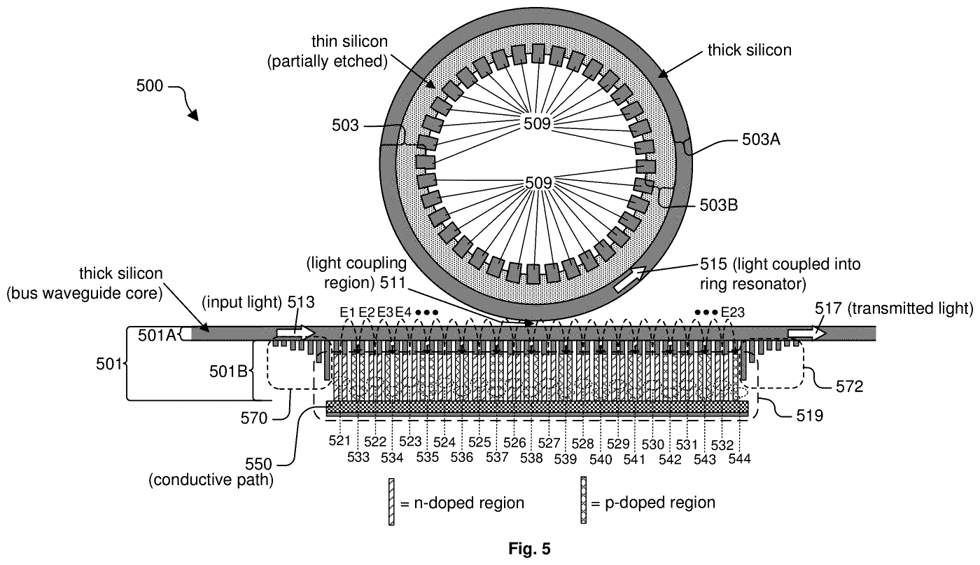

FIG. 5 shows a top view of an optical coupling configuration 500 between a bus waveguide 501 and a ring resonator 503, in accordance with some embodiments. The bus waveguide 501 is a fully etched silicon bus waveguide that has a core region 501A and a sub-wavelength half-cladding region 501B. The bus waveguide 501 conveys incoming light, as indicated by arrow 513, and conveys transmitted light, as indicated by arrow 517. In some embodiments, the core region 501A and the sub-wavelength half-cladding region 501B are formed to have a full thickness of a silicon layer within a PIC chip. In some embodiments, the sub-wavelength half-cladding region 501B is implemented along just a portion of the bus waveguide 501. In these embodiments, the sub-wavelength half-cladding region 501B includes adiabatically tapered regions 570 and 572 to transition between the solid core region 501A and the sub-wavelength half-cladded region 501B of the bus waveguide 501 with low optical loss.

The ring resonator 503 is configured as half-rib circuitous waveguide that has a core region 503A and an inner side region 503B. The core region 503A circles back into itself. In some embodiments, the core region 503A is formed to have a full thickness of the silicon layer within the PIC chip, substantially similar to the full thickness of the core region 501A of the bus waveguide 501. The inner side region 503B is formed to have less than the full thickness of the silicon layer. In some embodiments, the inner side region 503B is a partially etched region of the silicon layer within the PIC chip. In some embodiments, a series of spirally oriented full thickness silicon segments 509 are formed in a spaced apart configuration along and over the inner edge of the inner side region 503B of the ring resonator 503. In some embodiments, the full thickness silicon segments 509 are used for electrical connection with the ring resonator 503. The inner positioning of the full thickness silicon segments 509 keeps the electrical connections with the ring resonator 503 away from the primary optical mode of the core region 503A of the ring resonator 503 in order to prevent optical absorption by the materials of the electrical connections.

The core region 503A of the ring resonator 503 is positioned within an evanescent optical coupling distance of the core region 501A of the bus waveguide 501, so as to form an optical (light) coupling region 511 between the core region 503A of the ring resonator 503 and the core region 501A of the bus waveguide 501. During operation, light is conveyed through the bus waveguide 501, as indicated by arrow 513. The primary optical mode of the light is conveyed within the core region 501A of the bus waveguide 501. At least a portion of the light is coupled from the bus waveguide 501 into the ring resonator 503, and especially into the core region 503A of the ring resonator 503, as indicated by arrow 515. The light that is coupled into the ring resonator 503 is guided through the core region 503A in a circuitous manner. In some embodiments, upon returning to the optical coupling region 511, at least some of the light within the ring resonator 503 optically couples back into the bus waveguide 501 as transmitted light, as indicated by arrow 517. Also, in some embodiments, some of the input light 513 within the bus waveguide 501 that approaches the ring resonator 503 does not couple into ring resonator 503 and becomes part of the transmitted light, as indicated by arrow 517. For example, in some embodiments, the ring resonator 503 is controlled (e.g., thermally controlled) to have a particular waveband of resonance wavelength. In this example, a portion of the input light 513 within the bus waveguide 501 that approaches the ring resonator 503 and that has a wavelength within the particular waveband of resonance wavelength of the ring resonator 503 will substantially optically couple from the bus waveguide 501 into the ring resonator 503. Also, in this example, a portion of the input light 513 within the bus waveguide 501 that approaches the ring resonator 503 and that does not have a wavelength within the particular waveband of resonance wavelength of the ring resonator 503 will not substantially optically couple from the bus waveguide 501 into the ring resonator 503.

The optical coupling configuration 500 between the bus waveguide 501 and the ring resonator 503 is equipped with diode structures 519 that produce electric fields E1 to E23 across the optical coupling region 511 between the bus waveguide 501 and the ring resonator 503 to provide for sweep-out of TPA-generated free-carriers within the core region 501A of the bus waveguide 501, so as to mitigate optical loss due to FCA within the optical coupling region 511. In the example of FIG. 5, the diode structures 519 include n-doped regions 521-532 and p-doped region 533-544 positioned in an interdigitated alternating manner with regard to dopant type along the length of the bus waveguide 501, and particularly along the portion of the bus waveguide 501 that extends through the optical coupling region 511 between the bus waveguide 501 and the ring resonator 503. The n-doped regions 521-532 and p-doped region 533-544 are formed as fingers within the sub-wavelength half-cladding region 501B of the bus waveguide 501.

More specifically, the n-doped regions 521-532 and p-doped region 533-544 are formed in fingers (silicon fingers) of the sub-wavelength cladding region that connects the core region 501A of the bus waveguide 501 and a region where the p-n junctions within diode structures 519 are electrically shorted by an electrically conductive structure 550. One side of the bus waveguide 501 has the fingers of the sub-wavelength cladding region connected to the core region 501A and extending transverse to the direction of light propagation in the plane of the device layer. The fingers of the sub-wavelength cladding region form an array with an electrical insulator material (such as, but not limited to, an oxide or an interlayer dielectric) within the regions between adjacently positioned fingers of the sub-wavelength cladding region. The fingers of the sub-wavelength cladding region are electrically and physically connected with the silicon of the core region 501A of the bus waveguide 501. The alternating n-doped regions 521-532 and p-doped regions 533-544 are formed in the fingers of the sub-wavelength cladding region. In various embodiments, each of the n-doped regions 521-532 and p-doped regions 533-544 can include one or more fingers of the sub-wavelength cladding region. The example optical coupling configuration 500 of FIG. 5 shows two fingers of the sub-wavelength cladding region per n-doped region 521-532, and two fingers of the sub-wavelength cladding region per p-doped region 533-544. In some embodiments, the array of fingers of the sub-wavelength cladding region is electrically shorted by a solid silicon region on the opposite side of the fingers from core region 501A of the bus waveguide 501. In some embodiments, the electrically conductive structure 550 provides an electrically conductive path, such as a silicide, or an array of metal via and metal interconnects in the process material layer stack of the PIC chip in which the optical coupling configuration 500 is formed.

The silicon of the sub-wavelength half-cladding region 501B of the bus waveguide 501 next to the n-doped regions 521-532 and the p-doped regions 533-544 provides the intrinsic material to form P-I-N diodes of the diode structures 519. In this manner, the n-doped regions 521 and the p-doped regions 533 form a first P-I-N diode that generates a first electric field E1 across the bus waveguide 501. Similarly, the n-doped regions 522 and the p-doped regions 533 form a second P-I-N diode that generates a second electric field E2 across the bus waveguide 501. This pattern of diode formation continues along the remaining n-doped regions 523-532 and p-doped regions 534-544 to form the third through twenty-third P-I-N diodes that generate the third electric field E3 through the twenty-third electric field E23, respectively, across the bus waveguide 501. Additionally, the electrically conductive structure 550 is formed to directly electrically connect (electrically short) the n-doped regions 521-532 with the p-doped regions 533-544, in order to prevent free-carrier build-up that would weaken the electric fields E1-E23. In various embodiments, the electrically conductive structure 550 is formed as respective wire, a silicide region, a metal structure, or another type of electrically conductive structure that can be fabricated within a semiconductor chip fabrication process.

It should be understood that the particular number of n-doped regions 521-532 and p-doped regions 533-544 in the optical coupling configuration 500 is shown as an example to demonstrate unidirectional, one-sided free-carrier sweep out through the optical coupling region 511. In various other embodiments, essentially any number of alternatingly positioned n-doped regions and p-doped regions can be formed within the diode structures 519, along with formation of the electrically conductive structure 550 to electrically connect the n-doped regions and p-doped regions within the diode structures 519.

The functionality of the diode structures 519 with regard to free-carrier sweep-out from the bus waveguide 501, and especially from the core region 501A of the bus waveguide 501 is the same as described with regard to the diode structures 103 in the configuration of FIG. 1. Specifically, the electric fields E1 to E23 that are produced by the first through twenty-third P-I-N diodes of the diode structures 519 serve to push electrons toward the n-doped regions 521-532 and to push holes toward the p-doped regions 533-544. It should be understood that when the optical coupling region 511 includes both the incoming light 513 traveling along the bus waveguide 501 and some amount of light coupled from the ring resonator 503 back into the bus waveguide 501 to become transmitted light 517, the optical intensity within the optical coupling region 511 is increased and the probability of TPA is correspondingly increased. Therefore, having the diode structures 519 present along the optical coupling region 511 serves to substantially mitigate the increased probability of optical loss due to TPA and associated FCA. The diode structures 519 provide for non-linear mitigation of free-carriers that cause adverse optical absorption. It should be further appreciated that by having the diode structures 519 formed on just one side of the bus waveguide 501, the diode structures 519 do not interfere with positioning of the core region 503A (rib-shaped region) of the ring resonator 503 within the evanescent optical coupling distance of the core region 501A (rib-shaped region) of the bus waveguide 501. Also, it should be appreciated that by having the diode structures 519 formed on the side of the bus waveguide 501 opposite from the ring resonator 503, the materials of the n-doped regions 521-532 and the p-doped regions 533-544 and the electrically conductive structure 550 are collectively positioned away from the primary optical mode within the core region 501A of the bus waveguide 501, and away from the primary optical mode within the core region 503A of the ring resonator 503, and away from the optical coupling region 511 between the bus waveguide 501 and the ring resonator 503, so as to not cause adverse optical absorption.

For some waveguide structures it may be disadvantageous or not possible to support a diode for free-carrier sweepout, either because of constraints on space, or because the waveguide does not have a thinner slab region on either side of the core that can be doped and contacted to form a diode. A method to reduce non-linear loss in such waveguide structures includes doping of the core region of the waveguide in order to create defects in the crystal structure of the waveguide that accelerate carrier recombination and reduce non-linear absorption. It is understood that doping of the waveguide will increase the linear optical loss of the waveguide due to FCA. However, at sufficiently high optical powers the total optical absorption within a doped waveguide is lower than the total optical absorption within an undoped waveguide.

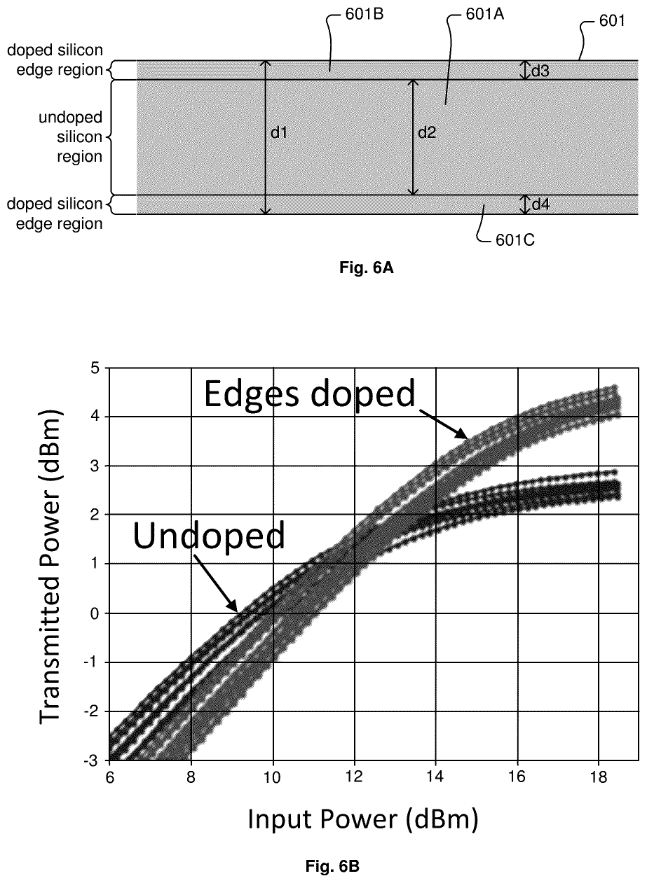

FIG. 6A shows an example of a strip waveguide 601 that is only doped along the edges of the strip waveguide 601, away from the peak optical power density of the waveguide mode, so as to reduce the linear FCA by the dopants, while capturing and recombining free-carriers as they diffuse to the sidewalls of the strip waveguide 601, in accordance with some embodiments. The diffusion length for generated electron-hole pairs in these processes can be many times the width of the waveguide. Therefore, enhancing recombination near the waveguide sidewalls will shorten the diffusion length, i.e., will reduce the effective free-carrier lifetime (τ). In the example of FIG. 6A, the strip waveguide 601 has a total width d1. The undoped core region 601A of the strip waveguide 601 has a width d2. A first doped edge region 601B of the strip waveguide 601 has a width d3. A second doped edge region 601C of the strip waveguide 601 has a width d4.

FIG. 6B shows measurements comparing the optical transmission of the strip waveguide 601 to a waveguide that is completely undoped, in accordance with some embodiments. The transmitted (output) optical power versus the input optical power is plotted for the strip waveguide 601 having the doped edges and for the comparable undoped waveguide, for many identical test sites (represented by the large number of curves). FIG. 6B shows that at high optical powers (greater than about 12 dBm), the strip waveguide 601 with the doped edge regions 601B and 601C provides higher optical transmission (output) than the comparable undoped waveguide.

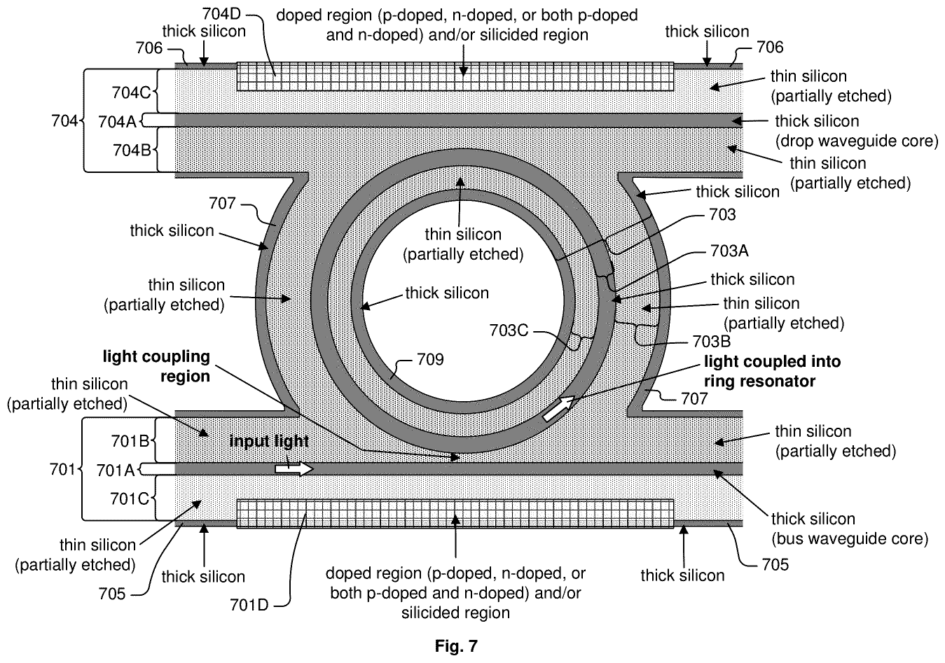

FIG. 7 shows an optical coupling configuration 700 between a bus waveguide 701, a ring resonator 703, and a drop waveguide 704 that implements the edge doping approach of FIG. 6A, in accordance with some embodiments. The bus waveguide 701 is configured as a rib waveguide that includes a core region 701A, a first side region 701B, and a second side region 701C. The drop waveguide 704 is configured as a rib waveguide that includes a core region 704A, a first side region 704B, and a second side region 704C. The ring resonator 703 is configured as an annular-shaped rib waveguide that includes a core region 703A, an outer side region 703B, and an inner side region 703C. In some embodiments, the each of the core regions 701A, 703A, 704A is formed to have a full thickness of a silicon layer within a PIC chip. Also, each of the first side region 701B, the second side region 701C, the first side region 704B, the second side region 704C, the outer side region 703B, and the inner side region 703C is formed to have less than the full thickness of the silicon layer (is formed as a partially etched region of the silicon layer).

In some embodiments, an outer frame region 705 is formed along the second side region 701C of the bus waveguide 701. Also, in some embodiments, an outer frame region 707 is formed along the outer side region 703B of the ring resonator 703. Also, in some embodiments, an outer frame region 706 is formed along the second side region 704C of the drop waveguide 704. Also, in some embodiments, an inner frame region 709 is formed along the inner side region 703C of the ring resonator 703. Each of the outer frame region 705, the outer frame region 707, the outer frame region 706, and the inner frame region 709 has the full thickness of the silicon layer within the PIC chip, substantially similar to each of the full thickness of the core region 701A of the bus waveguide 701, the full thickness of the core region 703A of the ring resonator 703, and the full thickness of the core region 704A of the drop waveguide 704. An outer edge region 701D of the bus waveguide 701, relative to the ring resonator 703, is doped to reduce the linear FCA by the dopants, such as described with regard to FIGS. 6A and 6B. An outer edge region 704D of the drop waveguide 704, relative to the ring resonator 703, is doped to reduce the linear FCA by the dopants, such as described with regard to FIGS. 6A and 6B.

FIG. 7 shows how the edge doping approach of FIGS. 6A and 6B can be applied to the bus waveguide 701 within the optical coupling region between the bus waveguide 701 and the ring resonator 703, where doping is placed in the outer edge region 701D which includes the full-thickness silicon region 705 outside the core region 701A, and/or the partially-etched silicon side region 701C outside of the core region 701A. Doping in the outer edge region 701D has no overlap or little overlap with the optical field, so it causes very little optical loss. However, the doping in the outer edge region 701D reduces the lifetime (τ) of the free-carriers that are generated by TPA, which significantly reduces the non-linear optical loss. The doping within the outer edge region 701D is either n-type, or p-type, or a combination of n dopants and p dopants so as to further reduce the free-carrier lifetime (τ). Also, in some embodiments, a silicided region is formed over the outer edge region 701D to further reduce free-carrier lifetime (τ).

FIG. 7 also shows how the edge doping approach of FIGS. 6A and 6B can be applied to the drop waveguide 704 within the optical coupling region between the drop waveguide 704 and the ring resonator 703, where doping is placed in the outer edge region 704D which includes the full-thickness silicon region 706 outside the core region 704A, and/or the partially-etched silicon side region 704C outside of the core region 704A. Doping in the outer edge region 704D has no overlap or little overlap with the optical field, so it causes very little optical loss. However, the doping in the outer edge region 704D reduces the lifetime (τ) of the free-carriers that are generated by TPA, which significantly reduces the non-linear optical loss. The doping within the outer edge region 704D is either n-type, or p-type, or a combination of n dopants and p dopants so as to further reduce the free-carrier lifetime (τ). Also, in some embodiments, a silicided region is formed over the outer edge region 704D to further reduce free-carrier lifetime (τ).

In some embodiments, ion bombardment is done to damage the silicon lattice and produce electronic defects, which serves to reduce free-carrier lifetime (τ) with limited impact on linear optical loss. In these embodiments, the silicon density is unchanged and the optical loss remains low. In some embodiments, ion bombardment is localized in prescribed regions, such as in the doped edge regions 601B and 601C of the waveguide 601 of FIG. 6A, and/or as in the doped outer edge regions 701D and 704D of the waveguides 701 and 704, respectively, of FIG. 7.

In various embodiments disclosed herein, non-linear optical loss is mitigated and/or avoided by creating a diode structure in silicon to sweep out free-carriers generated by TPA, or by using doping to reduce free-carrier lifetime (τ). Alternatively, in some embodiments, a waveguide material with a high band-gap is used, which will avoid TPA. For example, silicon nitride (SiN), which has a considerably higher band-gap than silicon, is usable in photonics systems to make waveguides that need to sustain high optical power. In some embodiments, the SiN that is used to form waveguides is positioned in a layer above the silicon in the material layer stack of the PIC chip.

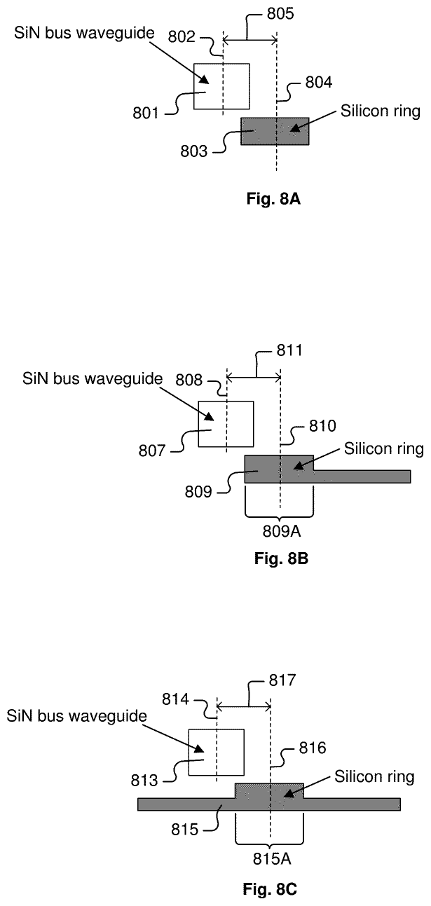

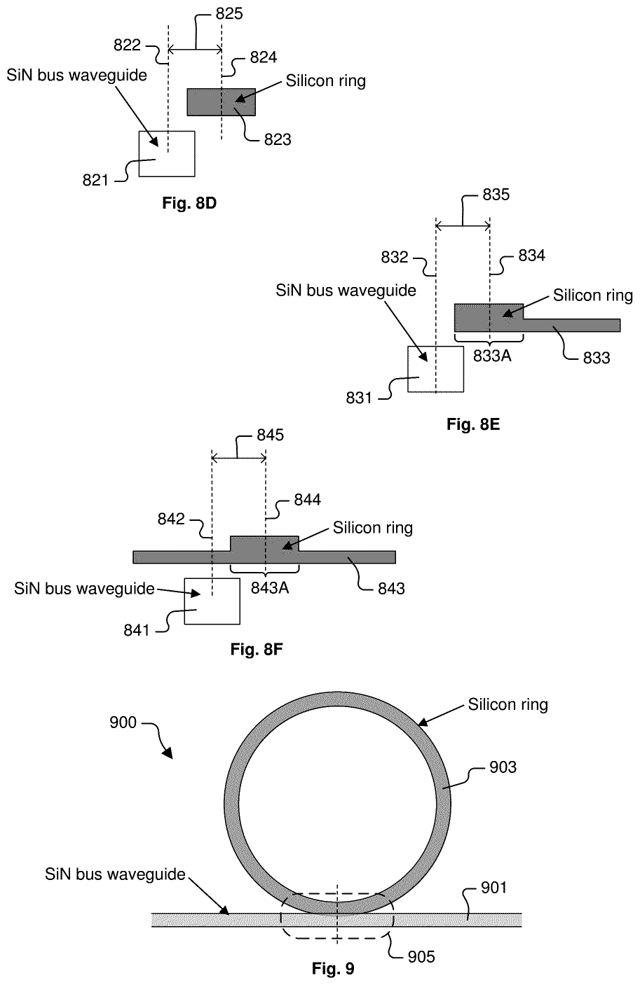

FIG. 8A shows a vertical cross-section of an optical coupling region between a SiN bus waveguide 801 and a silicon strip ring waveguide 803, where the SiN bus waveguide 801 is positioned above the silicon strip ring waveguide 803 in the material layer stack of the PIC chip, in accordance with some embodiments. A vertical centerline 802 of the SiN bus waveguide 801 is laterally separated from a vertical centerline 804 of the silicon strip ring waveguide 803 by a distance 805. In some embodiments, the distance 805 is defined so that a portion of the SiN bus waveguide 801 laterally overlaps a portion of the silicon strip ring waveguide 803. In some embodiments, the distance 805 is defined so that no portion of the SiN bus waveguide 801 laterally overlaps any portion of the silicon strip ring waveguide 803.

FIG. 8B shows a vertical cross-section of an optical coupling region between a SiN bus waveguide 807 and a silicon half-rib ring waveguide 809, where the SiN bus waveguide 807 is positioned above the silicon half-rib ring waveguide 809 in the material layer stack of the PIC chip, in accordance with some embodiments. A vertical centerline 808 of the SiN bus waveguide 807 is laterally separated from a vertical centerline 810 of a core region 809A of the silicon half-rib ring waveguide 809 by a distance 811. In some embodiments, the distance 811 is defined so that a portion of the SiN bus waveguide 807 laterally overlaps a portion of the core region 809A of the silicon half-rib ring waveguide 809. In some embodiments, the distance 811 is defined so that no portion of the SiN bus waveguide 807 laterally overlaps the core region 809A of the silicon half-rib ring waveguide 809.

FIG. 8C shows a vertical cross-section of an optical coupling region between a SiN bus waveguide 813 and a silicon rib ring waveguide 815, where the SiN bus waveguide 813 is positioned above the silicon rib ring waveguide 815 in the material layer stack of the PIC chip, in accordance with some embodiments. A vertical centerline 814 of the SiN bus waveguide 813 is laterally separated from a vertical centerline 816 of a core region 815A of the silicon rib ring waveguide 815 by a distance 817. In some embodiments, the distance 817 is defined so that a portion of the SiN bus waveguide 813 laterally overlaps a portion of the core region 815A of the silicon rib ring waveguide 815. In some embodiments, the distance 817 is defined so that no portion of the SiN bus waveguide 813 laterally overlaps the core region 815A of the silicon rib ring waveguide 815.

In some embodiments, the passive SiN device material layer is positioned below the silicon device layer in the material layer stack of the PIC chip. In some embodiments, with this configuration in which the SiN device material layer is positioned below the silicon device layer, the SiN device material layer is patterned (such as in a photolithography-based semiconductor fabrication process). Having the SiN device material layer positioned vertically below the silicon device layer is compatible with CMOS semiconductor fabrication processes. However, because the silicon device layer is usually single-crystalline silicon, having the SiN device material layer positioned vertically below the silicon device layer is generally not compatible with silicon-on-insulator (SOI) semiconductor wafer fabrication. In some embodiments, however, use of deposited polysilicon or bonded crystalline silicon for the silicon device layer enables having the SiN device material layer positioned vertically below the silicon device layer in the material layer stack of the PIC chip. A particular advantage of having the SiN device material layer positioned vertically below the silicon device layer in the material layer stack of the PIC chip is that the metal contacts and vias associated with the silicon device layer extend up through the material layer stack of the PIC chip (into the back-end-of-line (BEOL) metal interconnect levels of the PIC chip), and, therefore, will not optically interfere with optical devices formed in the underlying SiN device material layer.

FIG. 8D shows a vertical cross-section of an optical coupling region between a SiN bus waveguide 821 and a silicon strip ring waveguide 823, where the SiN bus waveguide 821 is positioned below the silicon strip ring waveguide 823 in the material layer stack of the PIC chip, in accordance with some embodiments. A vertical centerline 822 of the SiN bus waveguide 821 is laterally separated from a vertical centerline 824 of the silicon strip ring waveguide 823 by a distance 825. In some embodiments, the distance 825 is defined so that a portion of the SiN bus waveguide 821 laterally overlaps a portion of the silicon strip ring waveguide 823. In some embodiments, the distance 825 is defined so that no portion of the SiN bus waveguide 821 laterally overlaps any portion of the silicon strip ring waveguide 823.

FIG. 8E shows a vertical cross-section of an optical coupling region between a SiN bus waveguide 831 and a silicon half-rib ring waveguide 833, where the SiN bus waveguide 831 is positioned below the silicon half-rib ring waveguide 833 in the material layer stack of the PIC chip, in accordance with some embodiments. A vertical centerline 832 of the SiN bus waveguide 831 is laterally separated from a vertical centerline 834 of a core region 833A of the silicon half-rib ring waveguide 833 by a distance 835. In some embodiments, the distance 835 is defined so that a portion of the SiN bus waveguide 831 laterally overlaps a portion of the core region 833A of the silicon half-rib ring waveguide 833. In some embodiments, the distance 835 is defined so that no portion of the SiN bus waveguide 831 laterally overlaps the core region 833A of the silicon half-rib ring waveguide 833.

FIG. 8F shows a vertical cross-section of an optical coupling region between a SiN bus waveguide 841 and a silicon rib ring waveguide 843, where the SiN bus waveguide 841 is positioned below the silicon rib ring waveguide 843 in the material layer stack of the PIC chip, in accordance with some embodiments. A vertical centerline 842 of the SiN bus waveguide 841 is laterally separated from a vertical centerline 844 of a core region 843A of the silicon rib ring waveguide 843 by a distance 845. In some embodiments, the distance 845 is defined so that a portion of the SiN bus waveguide 841 laterally overlaps a portion of the core region 843A of the silicon rib ring waveguide 843. In some embodiments, the distance 845 is defined so that no portion of the SiN bus waveguide 841 laterally overlaps the core region 843A of the silicon rib ring waveguide 843.

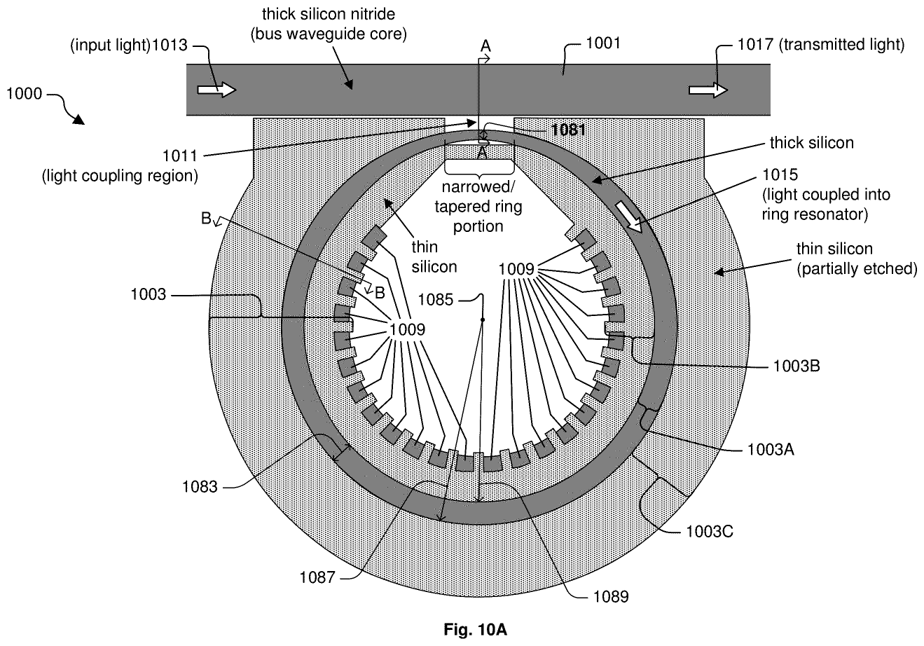

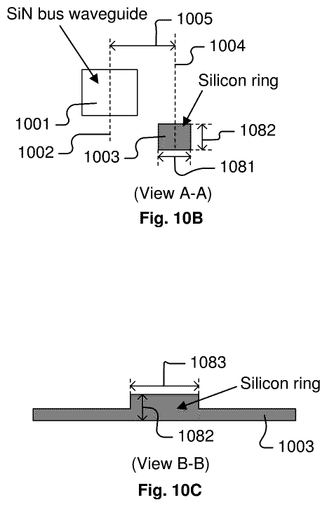

FIG. 9 shows a top view of an optical coupling configuration 900 between a SiN bus waveguide 901 and a silicon ring waveguide 903, in accordance with some embodiments. It should be noted that because the SiN material layer and the silicon material layer are at different vertical positions within the material layer stack of the PIC chip, it is possible for some lateral overlap to exist within an optical coupling region 905 between the SiN bus waveguide 901 and the silicon ring waveguide 903, such as depicted in FIG. 9, and such as described with regard to FIGS. 8A-8F. A significant challenge with the optical coupling configuration 900 between the SiN bus waveguide 901 and the silicon ring waveguide 903 is that light in SiN waveguides does not optically couple well to silicon waveguides. The guided optical modes of SiN waveguides that are typically used in optical data communication systems (the fundamental transverse electric (TE) or transverse magnetic (TM) optical modes) have a lower effective refractive index than the corresponding guided optical modes of silicon waveguides, which results in a propagation constant mismatch between the SiN waveguides and the silicon waveguides. This propagation constant mismatch frustrates optical power transfer, such as by causing low optical coupling efficiency from the SiN bus waveguide 901 to silicon ring waveguide 903 and/or from the silicon ring waveguide 903 to SiN bus waveguide 901. In some embodiments, one or both of the SiN bus waveguide 901 and the silicon ring waveguide 903 is/are altered in order to improve the optical coupling performance.

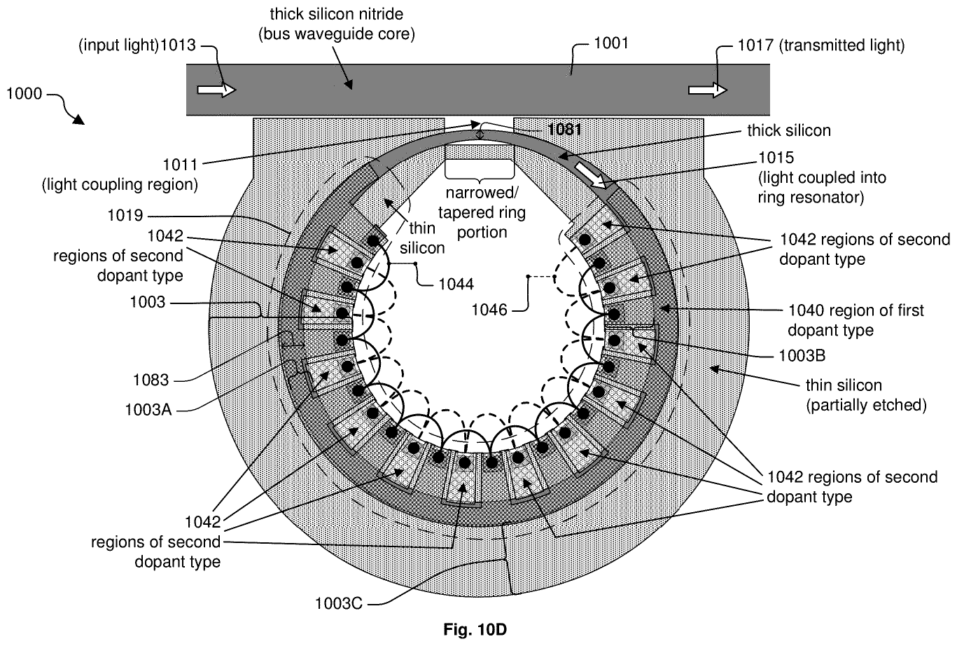

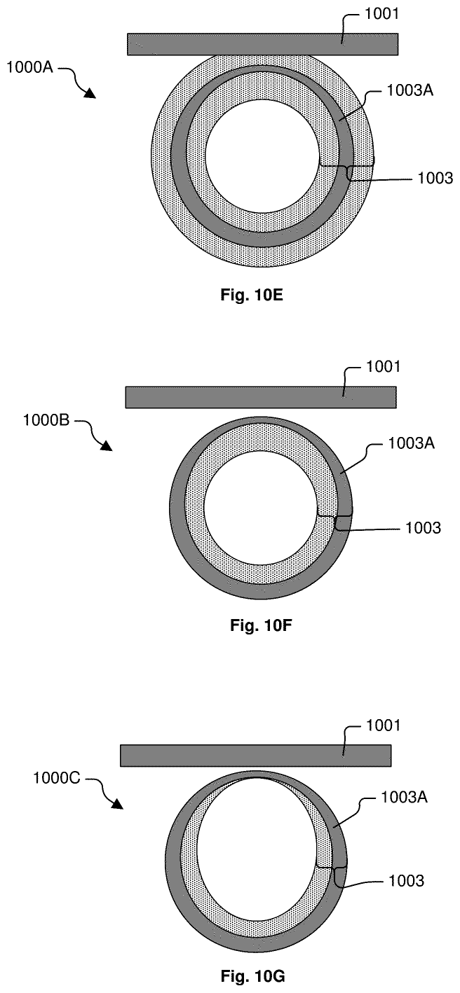

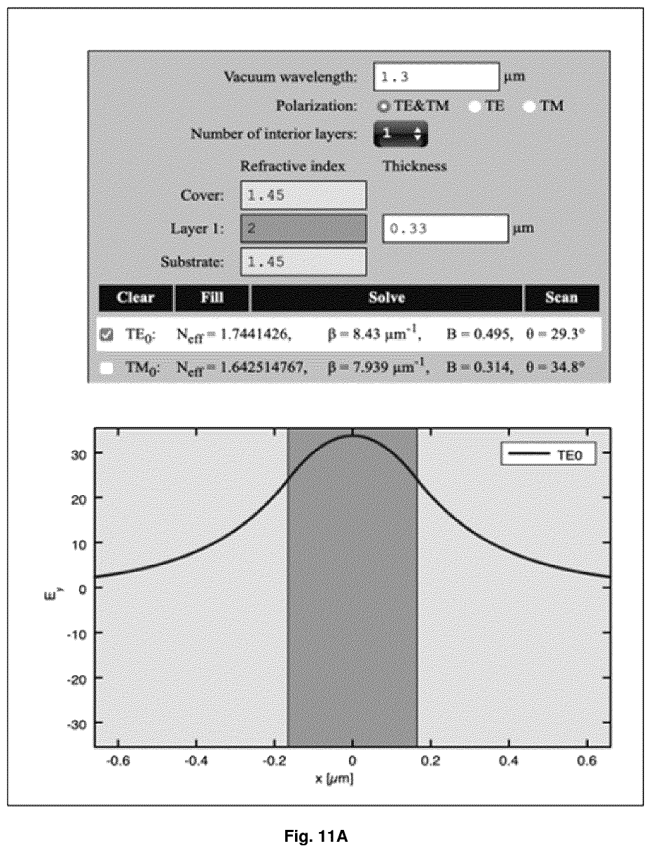

FIG. 10A shows a top view of an optical coupling configuration 1000 between a SiN bus waveguide 1001 and a silicon ring resonator 1003, in accordance with some embodiments. The SiN bus waveguide 1001 is configured as a strip waveguide. In some embodiments, the SiN bus waveguide 1001 is formed to have a full thickness of the SiN layer within the PIC chip. However, in some embodiments, the SiN bus waveguide 1001 is formed to have a thickness that is less than the full thickness of the SiN layer within the PIC chip. The silicon ring resonator 1003 is configured as an annular-shaped rib waveguide that has a core region 1003A, a inner side region 1003B, and outer side region 1003C. In some embodiments, the core region 1003A is formed to have a full thickness of the silicon layer within the PIC chip. Each of the inner side region 1003B and the outer side region 1003C is formed to have a thickness that is less than the full thickness of the silicon layer. In some embodiments, each of the inner side region 1003B and the outer side region 1003C is a respective partially etched region of the silicon layer within the PIC chip. Also, in some embodiments, a series of spirally oriented full thickness silicon segments 1009 are formed in a spaced apart configuration along and over the inner edge of the inner side region 1003B of the silicon ring resonator 1003. In some embodiments, the full thickness silicon segments 1009 are used for electrical connection with the silicon ring resonator 1003. The inner positioning of the full thickness silicon segments 1009 keeps the electrical connections with the silicon ring resonator 1003 away from the primary optical mode of the core region 1003A of the silicon ring resonator 1003 in order to prevent optical absorption by the materials of the electrical connections.

The core region 1003A of the silicon ring resonator 1003 is positioned within an evanescent optical coupling distance of the SiN bus waveguide 1001, so as to form an optical (light) coupling region 1011 between the core region 1003A of the silicon ring resonator 1003 and the SiN bus waveguide 1001. During operation, light is conveyed through the SiN bus waveguide 1001, as indicated by arrow 1013. The primary optical mode of the light is conveyed within the SiN bus waveguide 1001. At least a portion of the light is coupled from the SiN bus waveguide 1001 into the silicon ring resonator 1003, and especially into the core region 1003A of the silicon ring resonator 1003, as indicated by arrow 1015. The light that is coupled into the silicon ring resonator 1003 is guided through the core region 1003A in a circuitous manner. In some embodiments, upon returning to the optical coupling region 1011, at least some of the light within the silicon ring resonator 1003 optically couples back into the SiN bus waveguide 1001 as transmitted light, as indicated by arrow 1017. Also, in some embodiments, some of the input light 1013 within the SiN bus waveguide 1001 that approaches the silicon ring resonator 1003 does not couple into silicon ring resonator 1003 and becomes part of the transmitted light, as indicated by arrow 1017. For example, in some embodiments, the silicon ring resonator 1003 is controlled (e.g., thermally controlled) to have a particular waveband of resonance wavelength. In this example, a portion of the input light 1013 within the SiN bus waveguide 1001 that approaches the silicon ring resonator 1003 and that has a wavelength within the particular waveband of resonance wavelength of the silicon ring resonator 1003 will substantially optically couple from the SiN bus waveguide 1001 into the silicon ring resonator 1003. Also, in this example, a portion of the input light 1013 within the SiN bus waveguide 1001 that approaches the silicon ring resonator 1003 and that does not have a wavelength within the particular waveband of resonance wavelength of the silicon ring resonator 1003 will not substantially optically couple from the SiN bus waveguide 1001 into the silicon ring resonator 1003.

The silicon ring resonator 1003 is configured to provide improved optical coupling between the SiN bus waveguide 1001 and the silicon ring resonator 1003. Specifically, a portion of the core region 1003A of the silicon ring resonator 1003 that extends through the optical coupling region 1011 is tapered down in lateral width to a location of minimum lateral width at a position of closest approach to the SiN bus waveguide 1001. In this manner, a lateral width 1081 of the core region 1003A of the silicon ring resonator 1003 within the optical coupling region 1011 is less than a lateral width 1083 of the core region 1003A of the silicon ring resonator 1003 away from the optical coupling region 1011. In some embodiments, the lateral width of the core region 1003A of the silicon ring resonator 1003 is smoothly tapered down along the radial path of the core region 1003A of the silicon ring resonator 1003 in both directions that approach the optical coupling region 1011. In some embodiments, such as shown in the example of FIG. 10A, an outer radius 1087 of the core region 1003A of the silicon ring resonator 1003 is substantially uniform in the azimuthal direction about a center-point 1085 of the silicon ring resonator 1003, with the tapering of the lateral width of the core region 1003A of the silicon ring resonator 1003 being provided by adjustment of an inner radius 1089 of the core region 1003A of the silicon ring resonator 1003 as a function of azimuthal direction about the center-point 1085 of the silicon ring resonator 1003. In some embodiments, the inner radius 1089 of the core region 1003A of the silicon ring resonator 1003 is substantially uniform in the azimuthal direction about the center-point 1085 of the silicon ring resonator 1003, with the tapering of the lateral width of the core region 1003A of the silicon ring resonator 1003 being provided by adjustment of the outer radius 1087 of the core region 1003A of the silicon ring resonator 1003 as a function of azimuthal direction about the center-point 1085 of the silicon ring resonator 1003. In some embodiments, the tapering of the lateral width of the core region 1003A of the silicon ring resonator 1003 is provided by adjustment of both the outer radius 1087 and the inner radius 1089 of the core region 1003A of the silicon ring resonator 1003 as a function of azimuthal direction about the center-point 1085 of the silicon ring resonator 1003.

In some embodiments, the lateral width 1081 of the core region 1003A of the silicon ring resonator 1003 within the optical coupling region 1011 is configured so that the portion of the core region 1003A of the silicon ring resonator 1003 within the optical coupling region 1011 has an effective optical refractive index substantially close to an optical refractive index of the SiN bus waveguide 1001. In some embodiments, the tapering of the core region 1003A of the silicon ring resonator 1003 within the optical coupling region 1011 is done so that a shape of the core region 1003A of the silicon ring resonator 1003 within the optical coupling region 1011 approaches that of a strip waveguide. Also, in some embodiments, such as shown in the example of FIG. 10A, the inner side region 1003B and outer side region 1003C of the silicon ring resonator 1003 are fully etched along the portion of the core region 1003A of the silicon ring resonator 1003 that has the tapered lateral width within the optical coupling region 1011.

FIG. 10B shows a vertical cross-section of the optical coupling configuration 1000 through the optical coupling region 1011, referenced as View A-A in FIG. 10A, in accordance with some embodiments. In some embodiments, the SiN bus waveguide 1001 is positioned above the silicon ring resonator 1003 in the material layer stack of the PIC chip. A vertical centerline 1002 of the SiN bus waveguide 1001 is laterally separated from a vertical centerline 1004 of the silicon ring resonator 1003 by a distance 1005. The core region 1003A of the silicon ring resonator 1003 has the tapered down lateral width 1081 within the optical coupling region 1011. Also, the core region 1003A of the silicon ring resonator 1003 has a vertical height 1082. In some embodiments, the vertical height 1082 of the core region 1003A is a fully vertical thickness of the silicon layer within the PIC chip. In some embodiments, such as shown in the example of FIG. 10B, the distance 1005 is defined so that no portion of the SiN bus waveguide 1001 laterally overlaps any portion of the core region 1003A of the silicon ring resonator 1003. In other embodiments, the distance 1005 is defined so that a portion of the SiN bus waveguide 1001 laterally overlaps a portion of the core region 1003A of the silicon ring resonator 1003.

FIG. 10C shows a vertical cross-section of the optical coupling configuration 1000 through the silicon ring resonator 1003 at a location away from optical coupling region 1011, referenced as View B-B in FIG. 10A, in accordance with some embodiments. In the vertical cross-section of FIG. 10C, the silicon ring resonator 1003 has the rib-shape. Also, in the vertical cross-section of FIG. 10C, the core region 1003A of the silicon ring resonator 1003 has the full (non-tapered) lateral width 1083.

FIG. 10D shows the optical coupling configuration 1000 with diode structures 1019 (encompassed by the dashed line) formed over the core region 1003A of the silicon ring resonator 1003 to provide for sweep-out of TPA-generated free-carriers from the core region 1003A and thereby mitigate/prevent optical loss caused by FCA, in accordance with some embodiments. The diode structures 1019 are formed by a set of doped regions of a first dopant type 1040 interleaved with doped regions of a second dopant type 1042. The doped regions of the first dopant type 1040 are separated from the doped regions of the second dopant type 1042 by undoped portions of the silicon ring resonator 1003, which forms the intrinsic region of the P-I-N diodes formed by adjacently positioned ones of the doped regions of the first dopant type 1040 and the doped regions of the second dopant type 1042. The doped regions of the first dopant type 1040 are electrically connected together by electrical connections 1044. Also, the doped regions of the second dopant type 1042 are electrically connected together by electrical connections 1046. In the example optical coupling configuration 1000, the doped regions of the diode structures 1019 are not present within the optical coupling region 1011. However, in other embodiments, the doped regions of the diode structures 1019 extend into the optical coupling region 1011.

The diode structures 1019 produce electric fields across the core region 1003A of the silicon ring resonator 1003 that provide for sweep-out of TPA-generated free-carriers within the core region 1003A of the silicon ring resonator 1003, so as to mitigate optical loss due to FCA within the silicon ring resonator 1003. The functionality of the diode structures 1019 with regard to free-carrier sweep-out from the silicon ring resonator 1003, and especially from the core region 1003A of the silicon ring resonator 1003 is the same as described with regard to the diode structures 103 in the configuration of FIG. 1. Specifically, the electric fields that are produced by the diode structures 1019 serve to push electrons toward the n-doped regions and to push holes toward the p-doped regions. For example, if the doped regions of the first dopant type 1040 are n-type doped regions, and the doped regions of the second dopant type 1042 are p-type doped regions, then electrons are pushed toward the doped regions of the first dopant type 1040, and holes are pushed toward the doped regions of the second dopant type 1042. Alternatively, if the doped regions of the first dopant type 1040 are p-type doped regions, and the doped regions of the second dopant type 1042 are n-type doped regions, then electrons are pushed toward the doped regions of the second dopant type 1042, and holes are pushed toward the doped regions of the first dopant type 1040.

In the example optical coupling configuration 1000 of FIG. 10A, the portion of the silicon ring resonator 1003 near the SiN bus waveguide 1001 within the optical coupling region 1011 has a strip-type geometry. However, in other embodiments, the portion of the silicon ring resonator 1003 near the SiN bus waveguide 1001 within the optical coupling region 1011 is either a half-rib waveguide geometry or full-rib waveguide geometry.

For example, FIG. 10E shows a top view of an optical coupling configuration 1000A in which the silicon ring resonator 1003 has a full-rib waveguide geometry within the optical coupling region 1011, in accordance with some embodiments. FIG. 10F shows a top view of an optical coupling configuration 1000B in which the silicon ring resonator 1003 has a half-rib waveguide geometry within the optical coupling region 1011, in accordance with some embodiments. FIG. 10G shows a top view of an optical coupling configuration 1000C in which the silicon ring resonator 1003 has a strip-type waveguide geometry within the optical coupling region 1011 (similar to the optical coupling configuration 1000 of FIG. 10A), in accordance with some embodiments.

In some embodiments, the respective thicknesses of the silicon device layer (active layer) and SiN device layer (passive layer) are configured to support efficient optical coupling between the silicon device layer and the SiN device layer. In some embodiments, the silicon device layer is made thinner and SiN device layer is made thicker so that their effective optical indexes are closer to each other or equal to each other, such that optical coupling between the silicon device layer and the SiN device layer is more efficient by reducing or minimizing optical propagation constant mismatch. The effective optical index of the silicon device layer is represented by the thickness of the silicon device layer. The effective optical index of the SiN device layer is represented by the thickness of the SiN device layer. This is equivalent to having a patterned waveguide in either the silicon device layer or the SiN device layer with infinite in-plane width, and gives an upper bound on the effective optical index of each of the silicon device layer and the SiN device layer. In some embodiments, the configuration of the thicknesses of the silicon device layer (active layer) and SiN device layer (passive layer) is uniform across the semiconductor wafer. In some embodiments, the configuration of the thicknesses of the silicon device layer (active layer) and SiN device layer (passive layer) is different within different regions across the semiconductor wafer.

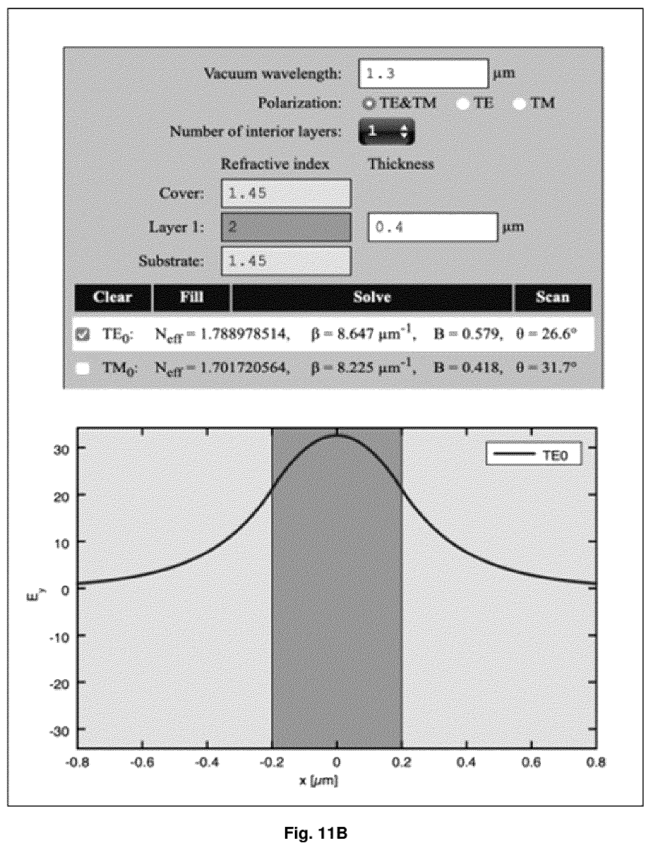

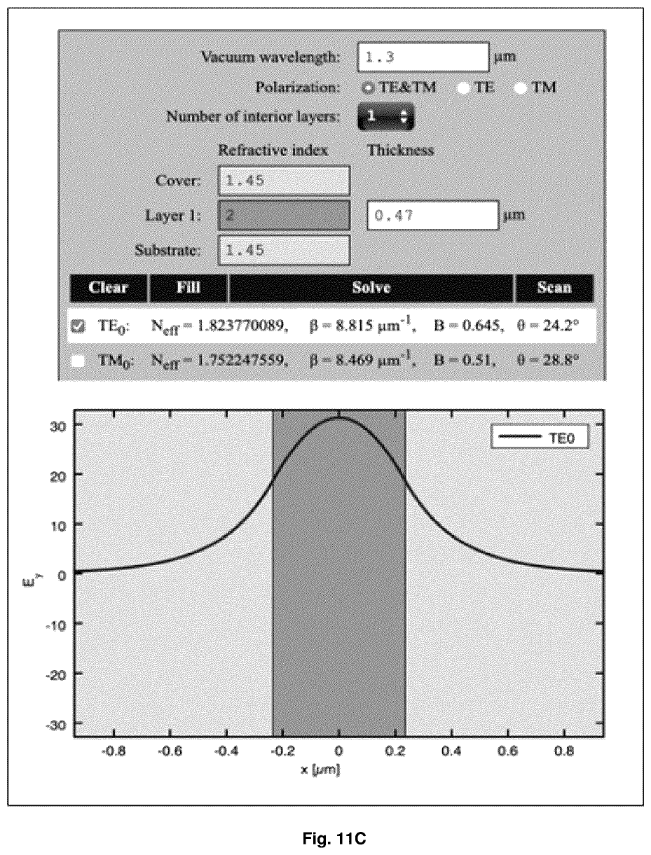

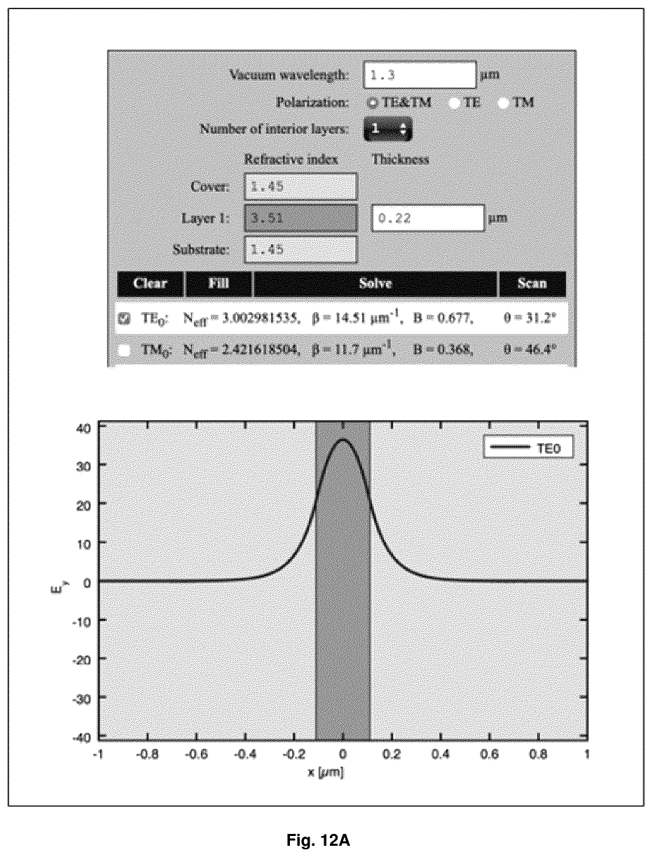

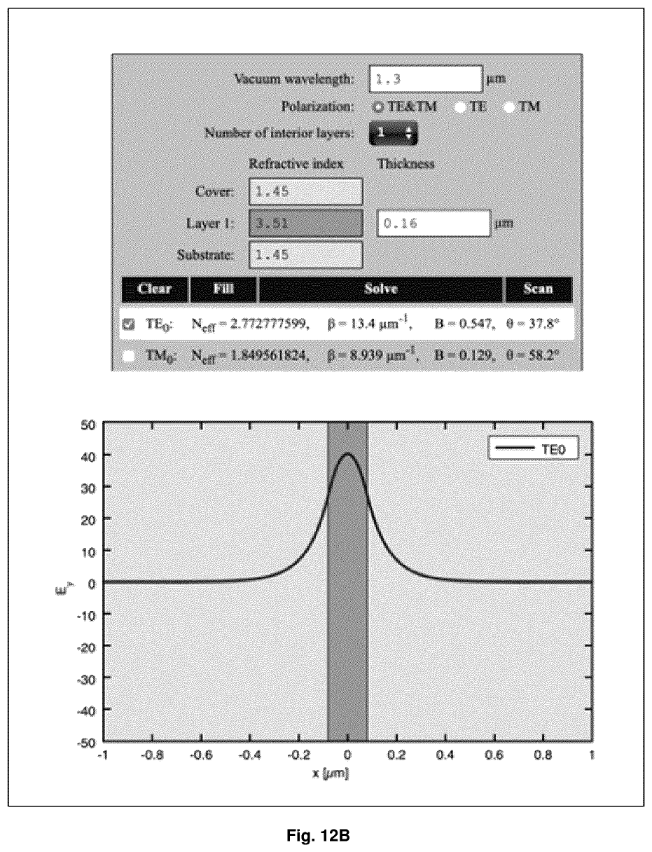

FIG. 11A shows the effective optical index versus device layer thickness for a silicon nitride (SiN) waveguide core having a thickness of 330 nanometers (nm) at 1300 nm operating light wavelength, in accordance with some embodiments. FIG. 11B shows the effective optical index versus device layer thickness for a silicon nitride (SiN) waveguide core having a thickness of 400 nm at 1300 nm operating light wavelength, in accordance with some embodiments. FIG. 11C shows the effective optical index versus device layer thickness for a silicon nitride (SiN) waveguide core having a thickness of 470 nm at 1300 nm operating light wavelength, in accordance with some embodiments.

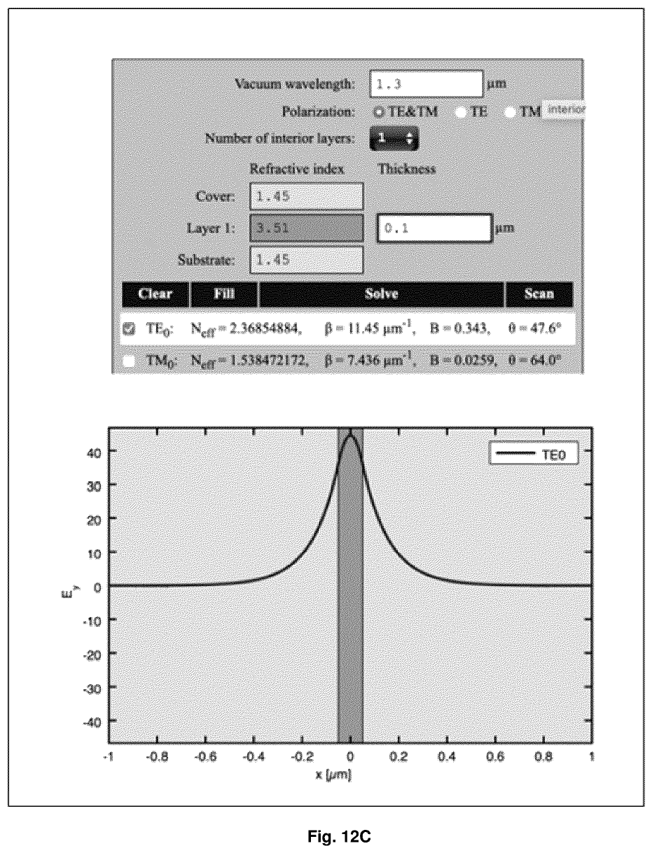

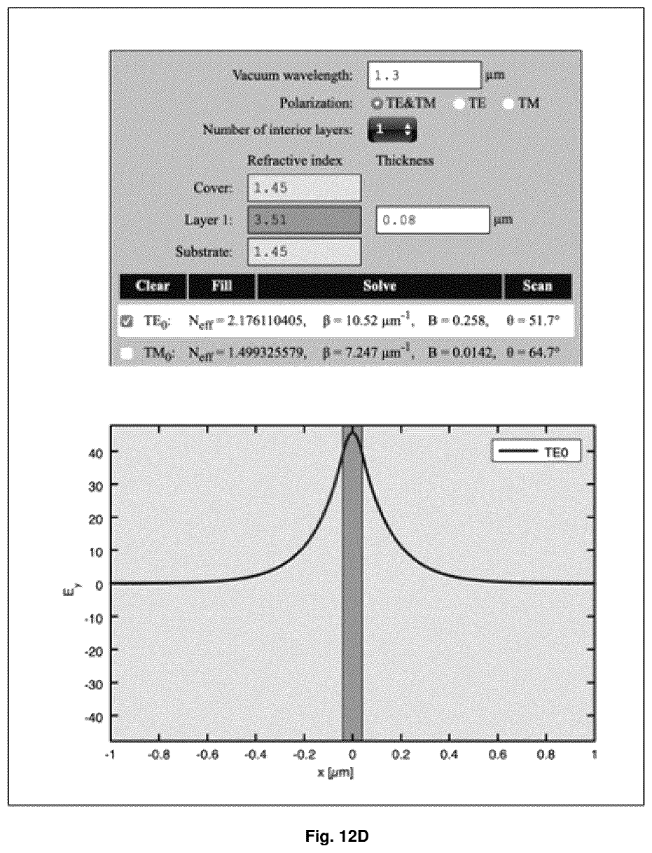

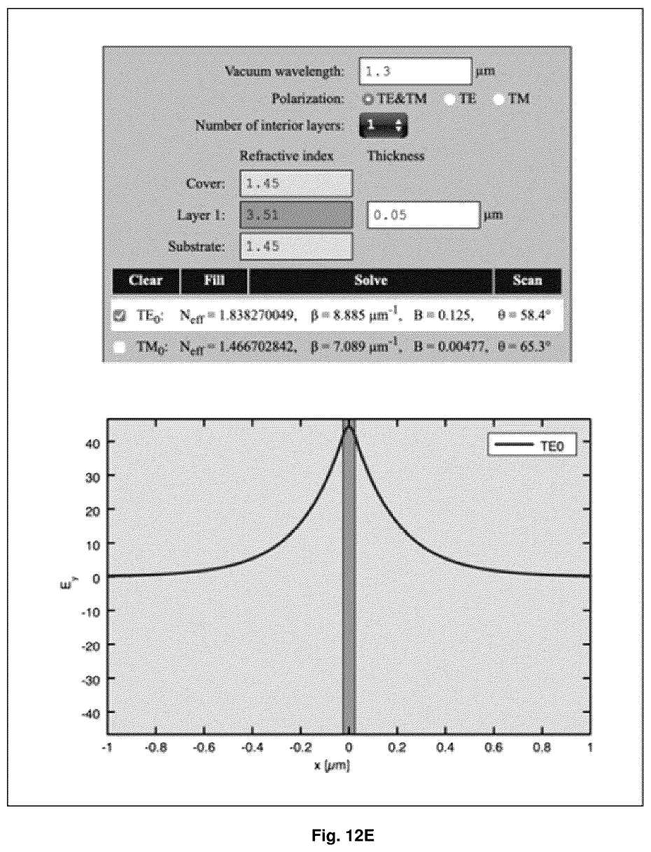

FIG. 12A shows the effective optical index versus device layer thickness for a silicon waveguide core having a thickness of 220 nm at 1300 nm operating light wavelength, in accordance with some embodiments. FIG. 12B shows the effective optical index versus device layer thickness for a silicon waveguide core having a thickness of 160 nm at 1300 nm operating light wavelength, in accordance with some embodiments. FIG. 12C shows the effective optical index versus device layer thickness for a silicon waveguide core having a thickness of 100 nm at 1300 nm operating light wavelength, in accordance with some embodiments. FIG. 12D shows the effective optical index versus device layer thickness for a silicon waveguide core having a thickness of 80 nm at 1300 nm operating light wavelength, in accordance with some embodiments. FIG. 12E shows the effective optical index versus device layer thickness for a silicon waveguide core having a thickness of 50 nm at 1300 nm operating light wavelength, in accordance with some embodiments.

FIGS. 12A through 12E indicate the respective cutoff widths before a higher order optical mode appears in the vertical direction at 1300 nm operating light wavelength. In some embodiments, the single optical mode condition is preferable. However, in some embodiments, waveguides having multiple optical modes, and especially weakly multimode, can still be efficiently used if higher optical modes are not excited by judicious resonator-waveguide or waveguide-waveguide coupling design. In an example embodiment, a 470 nm thick SiN device layer and a 50 nm thick silicon device layer support fundamental TE slab modes with an approximately equal effective optical index of about 1.82, which provides for fully synchronous layer-to-layer optical coupling.

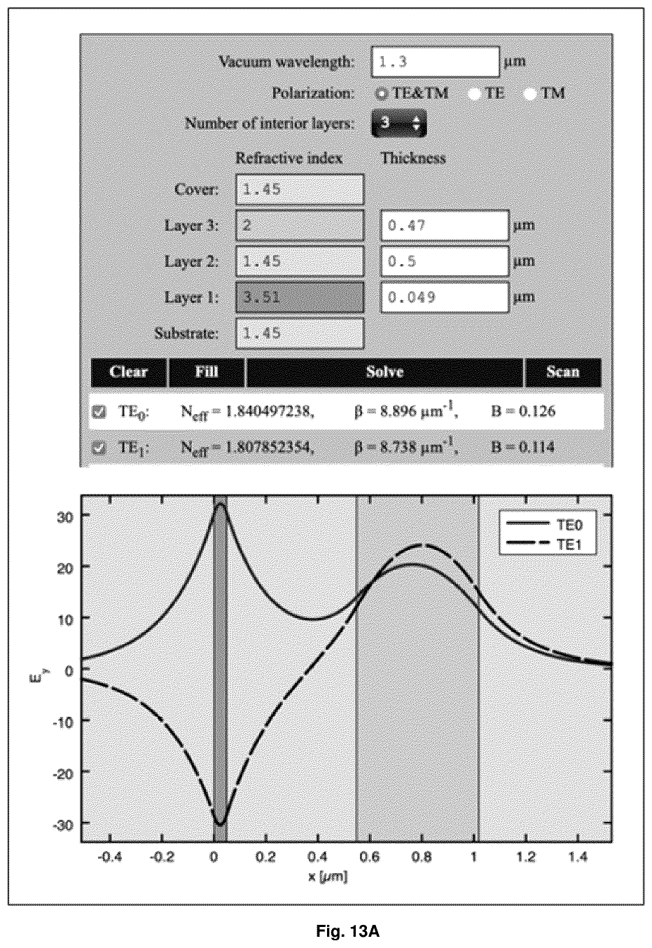

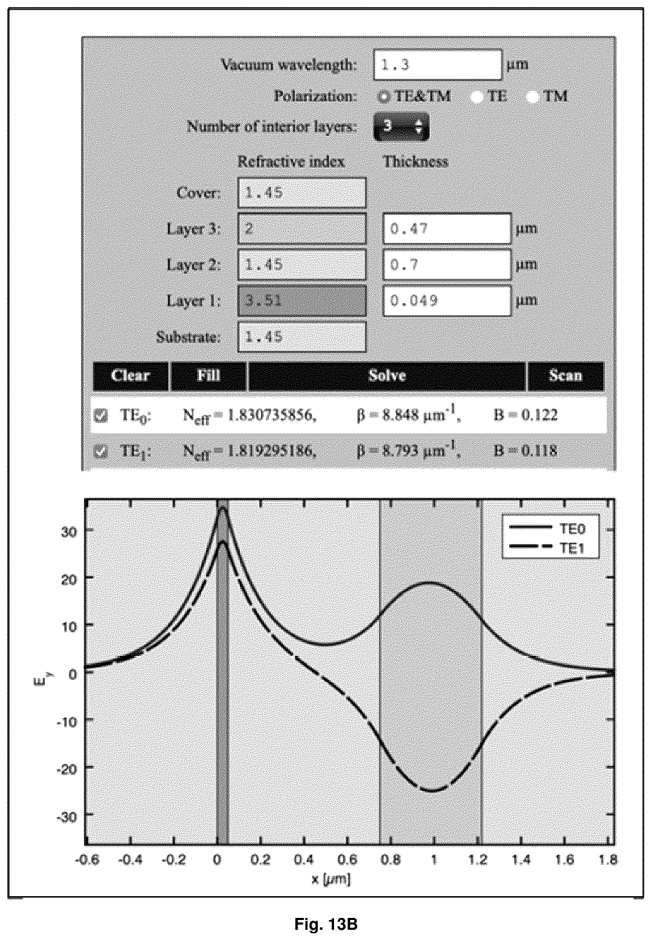

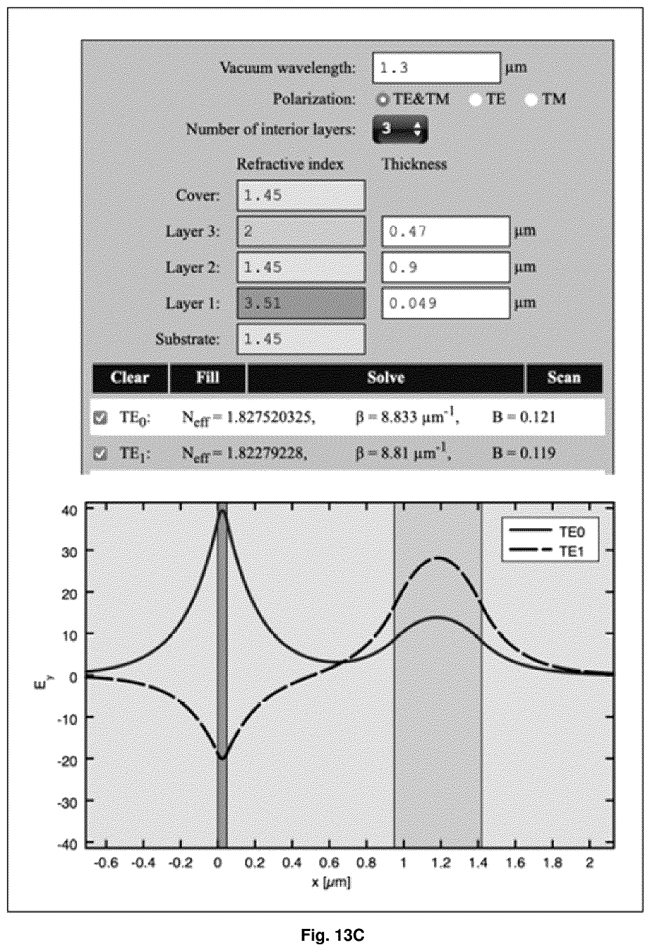

FIGS. 13A, 13B, and 13C shows the hybridization into supermodes that shows efficient optical coupling in the synchronous regime. FIG. 13A shows symmetric and antisymmetric supermodes for a gap size of 500 nm between a SiN optical waveguide and a silicon optical waveguide within an optical coupling region having an optical coupling length of 20 micrometers, in accordance with some embodiments. FIG. 13B shows symmetric and antisymmetric supermodes for a gap size of 700 nm between a SiN optical waveguide and a silicon optical waveguide within an optical coupling region having an optical coupling length of 57 micrometers, in accordance with some embodiments. FIG. 13C shows symmetric and antisymmetric supermodes for a gap size of 900 nm between a SiN optical waveguide and a silicon optical waveguide within an optical coupling region having an optical coupling length of 137 micrometers, in accordance with some embodiments.

Transverse patterning of waveguides in these device layers will reduce the effective optical index slightly but still allow optical propagation constant matching. The various examples shown herein include the highest effective optical index example. Thinner corresponding thickness device layers of both SiN and silicon can also support equal effective optical indexes, for smaller values of effective optical index. The disadvantage of lower effective optical index, however, is poorer optical mode confinement, and larger minimum bend radius of the waveguide that ensures bending without large optical losses. In some embodiments, matched effective optical index device thickness layers of SiN and silicon are used to simultaneously support strong optical mode confinement and reasonably small bend radius (larger layer thickness), while maintaining single-mode operation (lower thickness), and effective optical index matching or at least sufficient similarity (lower thickness of Si).

In the optical propagation constant matched example described herein, the disparity of device layer thicknesses may be too large and may introduce a limitation on bend radius in at least one of two ways. In a first way, it may require the silicon device layer to be so thin as to require large bend radii that make some silicon layer active devices less efficient, such as ring modulators. In a second way, if silicon-to-SiN layer waveguide optical coupling is weak, and the silicon waveguide is curved, such as in the case of a silicon ring resonator, the SiN waveguide will need to follow it for a considerable propagation distance to ensure a certain desired optical power transfer (coupling), which will require the SiN device layer waveguide to bend with the silicon waveguide. While for equal effective indices, the SiN waveguide's minimum bend radius should be similar to that of the silicon device layer, depending on the particular cross-section, the minimum radius in SiN may be larger due to reduced optical index contrast, which may not be able to follow the silicon waveguide. In this case, the SiN waveguide could have a larger radius and follow the silicon curved waveguide for only a limited propagation distance.

In some embodiments, improvements are achieved by leveraging two insights: 1) the silicon device layer may require a lower bend loss (if it forms a high-Q resonator, by way of example) while the SiN layer may be able to tolerate a higher bend loss if it forms a bus waveguide, which has a bend that follows the ring in a coupling region, and sees only a single-pass loss that affects device efficiency less; and 2) regardless of whether the silicon (active) and SiN (passive) device layers can tolerate similar or different bend losses, in the event of curved couplers, the two waveguides have different effective indices to be synchronous, since they must have the same angular propagation constant, which means that the waveguide that is radially further out has a lower effective index. This second insight can be leveraged to advantage. The silicon waveguide can be made thicker from the effective-index-matched case to in turn enable a smaller bend radius, and smaller active devices such as ring modulators, without going multimode. Meanwhile, it may not be preferable to make the SiN waveguide device layer thicker, either because it could become multimode, or because of fabrication process limitations imposed by stress in the case of SiN deposition, or other reasons. In this case, a curved SiN bus waveguide can be radially further out, and the silicon ring waveguide radially further inward. The aforementioned concept is shown in FIGS. 8A, 8B, and 8C, with consideration that the center of curved waveguides in FIGS. 8A, 8B, and 8C is on the right, and the waveguides are “turning” right. So long as the radial displacement is not too large, and the evanescent fields of the mode of the silicon waveguide and mode of the SiN waveguide overlap, effective optical coupling can be retained. In this case, several things are accomplished: 1) the silicon curved waveguide is allowed a thicker device layer and has small radius, allowing a compact active device; 2) the SiN bus waveguide can match its effective index via radius difference matching rather than effective optical index matching, allowing efficient optical coupling; and 3) the radially outward position of SiN bus allows the SiN waveguide to not interfere with back end metal interconnects contacting the silicon device, which could be radially inward from the silicon waveguide (in geometries such as those shown in FIGS. 8A, 8B, and 8C).

In order to achieve effective index matching in concentric silicon and SiN waveguides, it is necessary to match the angular propagation constants. The angular propagation constant (γ) in rad/rad, is the accumulated propagation phase (in radians) per propagation around the circular path (in radians), and is related to the effective optical index as shown in Equation 2, where effective optical index is (n_{eff}), (kₒ=2π/λ) is the free space wave vector (radians per meter), (λ) (meters) is the free space wavelength, and (R) is the bend radius (meters).

$$γ ≡ β R = {n}_{eff} {k}_{o} R . \qquad Equation 2$$

The angular propagation constant matching between a first waveguide characterized by γ₁, n_{eff1}, and R₁, e.g., the silicon device layer, and a second waveguide characterized by γ₂, n_{eff2}, R₂, e.g., the SiN device layer, which are concentric, is given by Equations 3, 4, and 5.

$${γ}_{1} = {γ}_{2} . \qquad Equation 3$$

$${n}_{eff 1} {R}_{1} = {n}_{eff 2} {R}_{2} \qquad Equation 4$$

$$\frac{{n}_{eff 1}}{{n}_{eff 2}} = \frac{{R}_{2}}{{R}_{1}} . \qquad Equation 5$$

Thus, for equal radii, effective indices should be equal. However, if one waveguide, the SiN (passive-layer) waveguide, has a lower effective index for the utilized guided mode, it should be at a larger radius (radially outward), and it can still meet the optical propagation constant matching condition to ensure efficient optical coupling. In some embodiments, the higher effective optical index waveguide is radially inward, and the lower effective optical index waveguide is radially outward. In some embodiments, the higher effective optical index waveguide utilizes a higher optical index core material such as silicon, and the lower effective index waveguide utilizes a lower optical index material such as silicon nitride. This allows the optical propagation constant matching. This also allows both waveguides to be well-confining. This also allows the lower effective optical index waveguide to use a larger radius and avoid excessive bending losses. FIGS. 8A, 8B, and 8C shows the above-mentioned example configuration, with consideration that the depicted waveguide cross-section is for concentric curved waveguides with the center of concentricity to the right of the depicted waveguide cross-section.

The described radius-mismatch-engineered optical propagation constant matching provides the greatest ability to accommodate different effective indices (and thus support optimal confinement in both silicon (active) and SiN (passive) waveguide layers) when the radii are smallest. This is because the radius difference can only be on the order of a single-mode waveguide width before coupling is lost. Thus, if n_{eff}2=n_{eff}1+Δn_{eff}, where Δn_{eff} is the effective index difference that can be tolerated while ensuring propagation constant matching, and R₂=R₁+ΔR, where ΔR is fixed (limited) in size as described, then the relationships of Equations 6 and 7 hold.

$$\frac{{n}_{eff 1}}{{n}_{eff 2}} = \frac{{n}_{eff 2} - Δ {n}_{eff}}{{n}_{eff 2}} = 1 - \frac{Δ {n}_{eff}}{{n}_{eff 2}} = \frac{{R}_{1} + Δ R}{{R}_{1}} = 1 + \frac{Δ R}{{R}_{1}} . \qquad Equation 7$$

$$\frac{Δ {n}_{eff}}{{n}_{eff 2}} = - \frac{Δ R}{{R}_{1}} . \qquad Equation 8$$

Equations 6 and 7 show that the Δn_{eff} can be largest while still maintaining perfect optical propagation constant matching (efficient interlayer coupling) if R₁ is smallest. Thus, this favors small radius devices, which is also preferable for high density and small capacitance/energy devices. The minimum usable radius will be limited by loss (e.g., bending radiation loss) or coupler loss. Even when the lower effective optical index passive-layer (e.g. SiN) waveguide is radially outward, the larger radius may not be sufficiently larger to compensate for the lower effective optical index needed for propagation constant matching and maintaining low bending radiation loss. However, the needed optical coupling length, i.e., distance over which the two curved waveguides are optically coupled, is finite. In some embodiments, the optical coupling length needs to be a few micrometers. In some embodiments, the optical coupling length needs to be 10-20 micrometers. Thus, the radius of the lower optical index waveguide can be made larger, such that the waveguides substantially overlap only over the desired effective optical coupling length, and slowly spread apart before and after the closest optical coupling point. Furthermore, the optical propagation constant matching does not need to be perfect. That is, if there is a small difference in effective optical index, optical coupling will still be efficient over a shorter distance. Thus, the effective optical index difference only needs to be small enough to avoid frustrating optical coupling over the needed optical coupling length. Allowing a larger radius, and an effective optical index mismatch in the nitride waveguide provides for: 1) a further increase in the confinement through an increase in silicon layer thickness to allow an effective optical index difference; and 2) a reduction in the silicon layer radius below that which is tolerable for the SiN waveguide layer. It should be understood that the above-mentioned device features can be implemented in any of the various embodiments disclosed herein.

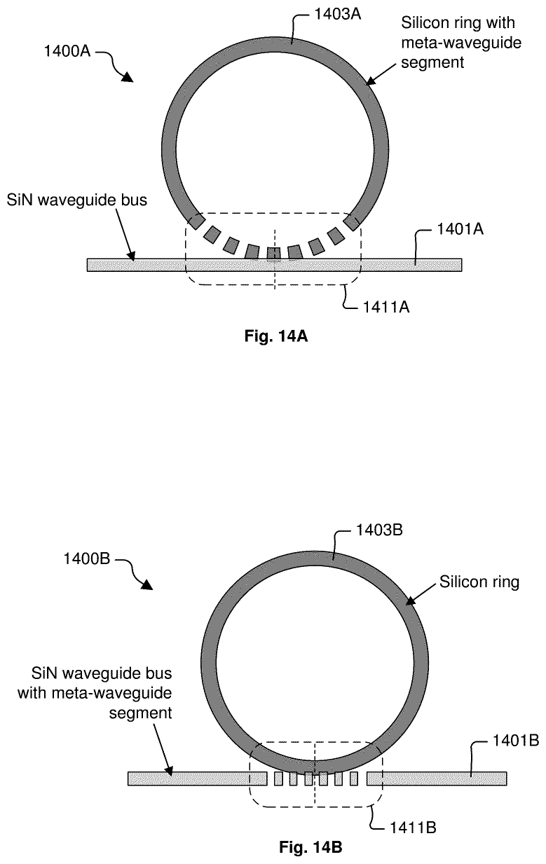

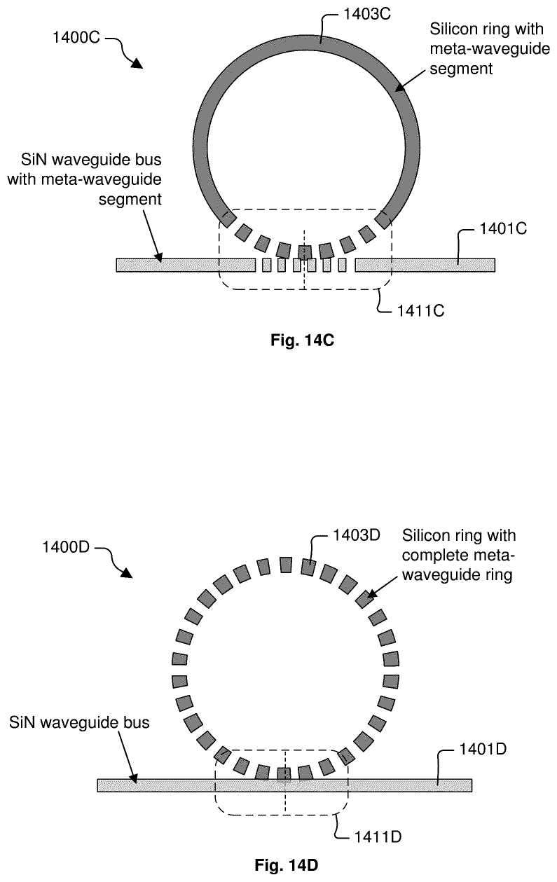

In some situations, the device layers in manufacturing platforms may not be open to custom device layer thickness. In that case, there are alternative approaches to matching optical propagation constants. Meta-material structured waveguides (also known as sub-wavelength gratings) provide additional degrees of freedom to engineer the effective refractive optical index of the waveguide or ring modes. This is important in cases where optical coupling between two waveguide types (e.g., silicon and silicon nitride) is limited by the phase mismatch between the waveguide modes. FIGS. 14A, 14B, 14C, and 14D depict several configurations where the ring waveguide and/or the bus waveguide are modified as a meta-material in order to achieve better optical coupling due to the ability to engineer the effective optical index of the system. This strategy can also be used in conjunction with the tapering schemes discussed with regard to FIGS. 10A through 10G. In meta-material structured waveguide embodiments, a critical dimension is that the gratings patterned into the material are sub-wavelength, meaning that every local grating period is smaller than the wavelength of light propagating in the material. The grating can be patterned with a complete etch or partial etch, as a degree-of-freedom, to accomplish the necessary phase-matching.

FIG. 14A shows a top view of an optical coupling configuration 1400A in which a silicon ring waveguide 1403A is optically coupled to a SiN bus waveguide 1401A, in accordance with some embodiments. A portion of the silicon ring waveguide 1403A is configured as a meta-material structured waveguide within an optical coupling region 1411A between the silicon ring waveguide 1403A and the SiN bus waveguide 1401A.

FIG. 14B shows a top view of an optical coupling configuration 1400B in which a silicon ring waveguide 1403B is optically coupled to a SiN bus waveguide 1401B, in accordance with some embodiments. A portion of the SiN bus waveguide 1401B is configured as a meta-material structured waveguide within an optical coupling region 1411B between the silicon ring waveguide 1403B and the SiN bus waveguide 1401B.

FIG. 14C shows a top view of an optical coupling configuration 1400C in which a silicon ring waveguide 1403C is optically coupled to a SiN bus waveguide 1401C, in accordance with some embodiments. A portion of the silicon ring waveguide 1403C is configured as a meta-material structured waveguide within an optical coupling region 1411C between the silicon ring waveguide 1403C and the SiN bus waveguide 1401C. Also, a portion of the SiN bus waveguide 1401C is configured as a meta-material structured waveguide within the optical coupling region 1411C between the silicon ring waveguide 1403C and the SiN bus waveguide 1401C.

FIG. 14D shows a top view of an optical coupling configuration 1400D in which a silicon ring waveguide 1403D is optically coupled to a SiN bus waveguide 1401D within an optical coupling region 1411D, in accordance with some embodiments. An entirety of the silicon ring waveguide 1403D is configured as a meta-material structured waveguide.

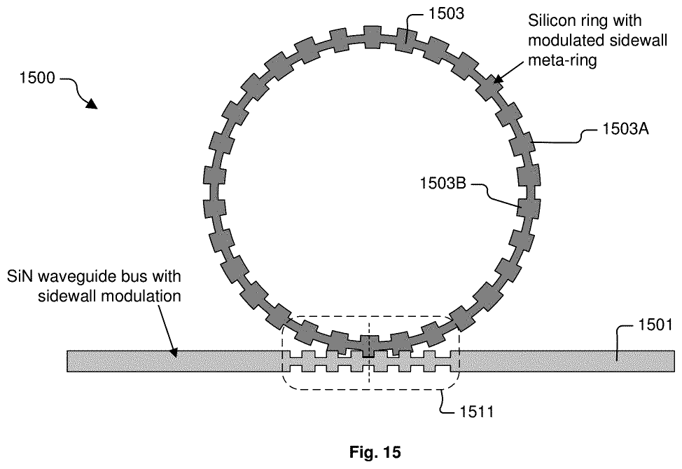

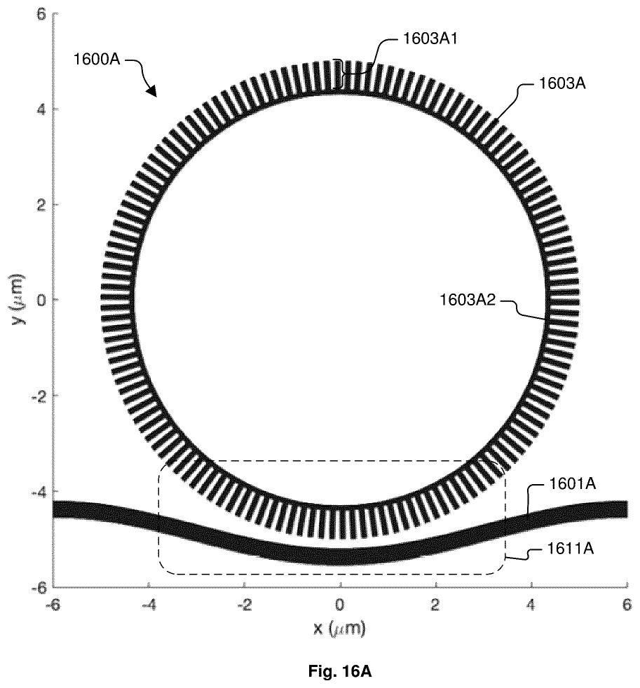

In some embodiments, periodic modulations in the sidewall may be employed in a strip geometry, or in conjunction with complete etching of grating elements. FIG. 15 shows a top view of an optical coupling configuration 1500 in which a silicon ring waveguide 1503 is optically coupled to a SiN bus waveguide 1501 within an optical coupling region 1511, in accordance with some embodiments. An entirety of the silicon ring waveguide 1503 is configured to have a meta-material outer sidewall 1503A and a meta-material inner sidewall 1503B. Also, a portion of the SiN bus waveguide 1501 is configured as a meta-material structured waveguide within the optical coupling region 1511 between the silicon ring waveguide 1503 and the SiN bus waveguide 1501.

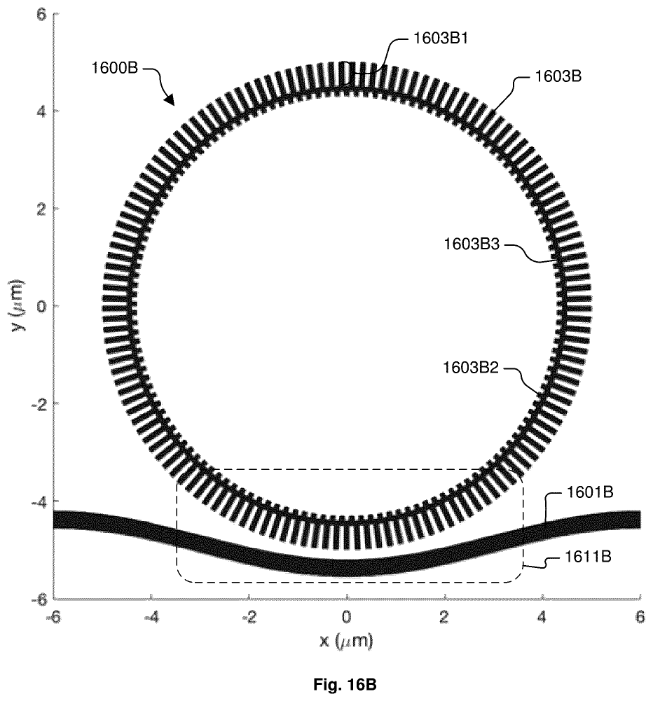

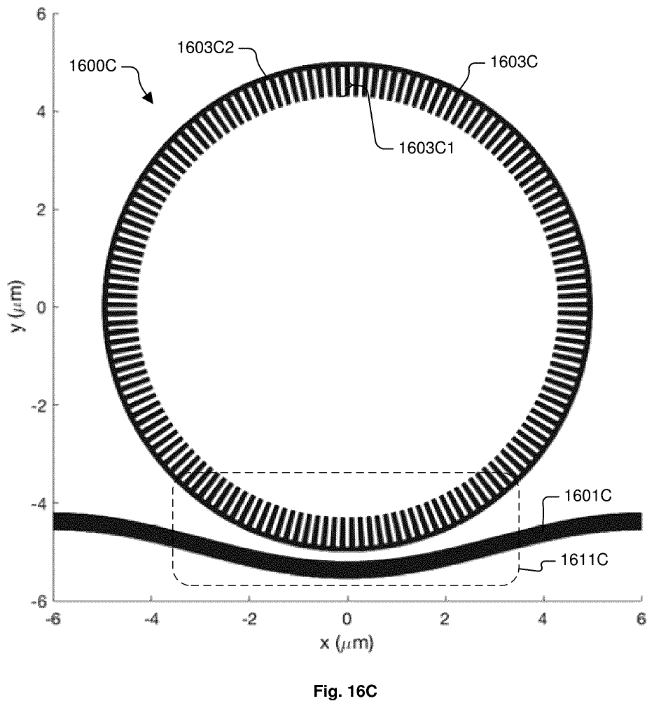

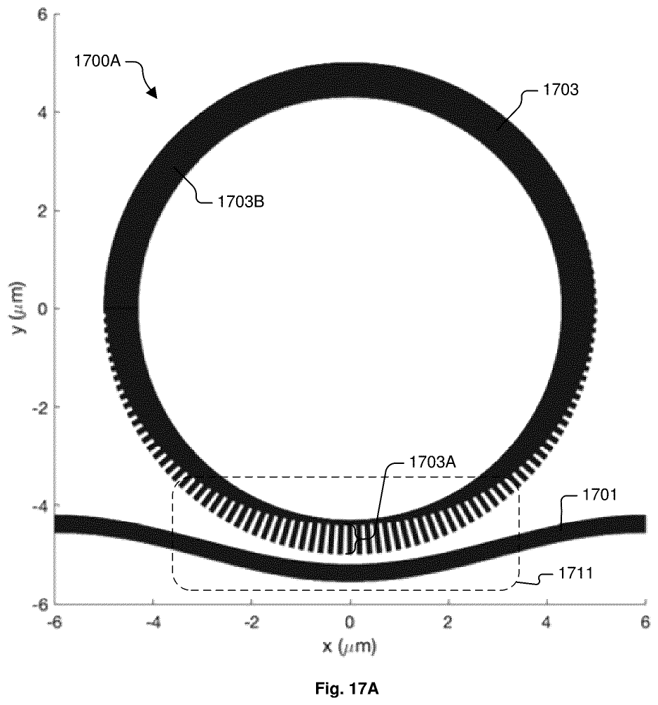

In some embodiments, a smooth transition of the silicon ring resonator to lower effective optical index is achieved by using a sub-wavelength patterned structure on an outer radial sidewall of the silicon ring resonator, in conjunction with a solid structure on an inner radial sidewall of the silicon ring resonator. In these embodiments, corrugation of the silicon ring resonator is present only along the outer radial side of the silicon ring resonator. FIG. 16A shows a top view of an optical coupling configuration 1600A in which a ring waveguide 1603A is optically coupled to a bus waveguide 1601A within an optical coupling region 1611A, in accordance with some embodiments. An entire circumference of an outer radial portion 1603A1 of the ring waveguide 1603A is configured to have a sub-wavelength patterned structure (meta-material structure), in conjunction with a solid rib structure along an entire circumference of an inner radial portion 1603A2 of the ring waveguide 1603A. In some embodiments, a radial length of the sub-wavelength patterned structures within the outer radial portion 1603A1 is substantially uniform around the circumference of the ring waveguide 1603A, and the radial width of the inner radial portion 1603A2 is substantially uniform around the circumference of the ring waveguide 1603A. However, in some embodiments, one or more of the radial length of the sub-wavelength patterned structures within the outer radial portion 1603A1 and the radial width of the inner radial portion 1603A2 varies at different circumferential positions along the ring waveguide 1603A. The bus waveguide 1601A is configured as a solid structured strip-type waveguide that curves around a portion of the ring waveguide 1603A within the optical coupling region 1611A between the ring waveguide 1603A and the bus waveguide 1601A, in accordance with the curvature considerations discussed herein.

FIG. 16B shows a top view of an optical coupling configuration 1600B in which a ring waveguide 1603B is optically coupled to a bus waveguide 1601B within an optical coupling region 1611B, in accordance with some embodiments. An entire circumference of an outer radial portion 1603B1 of the ring waveguide 160BA is configured to have a sub-wavelength patterned structure (meta-material structure). An entire circumference of an inner radial portion 1603B2 of the ring waveguide 1603B is configured to have a sub-wavelength patterned structure (meta-material structure). Also, a solid rib structure is formed along the entire circumference of the ring waveguide 1603B at a radial location between the outer radial portion 1603B1 and the inner radial portion 1603B2 of the ring waveguide 1603B. In some embodiments, such as shown in FIG. 16B, a radial length of the sub-wavelength patterned structures within the outer radial portion 1603B1 is longer than a radial length of the sub-wavelength patterned structures within the inner radial portion 1603B2. In some embodiments, the radial length of the sub-wavelength patterned structures within the outer radial portion 1603B1 is substantially equal to the radial length of the sub-wavelength patterned structures within the inner radial portion 1603B2. In some embodiments, the radial length of the sub-wavelength patterned structures within the outer radial portion 1603B1 is less than the radial length of the sub-wavelength patterned structures within the inner radial portion 1603B2. Also, in some embodiments, the radial length of the sub-wavelength patterned structures within the outer radial portion 1603B1 is substantially uniform around the circumference of the ring waveguide 1603B, and the radial length of the sub-wavelength patterned structures within the inner radial portion 1603B2 is substantially uniform around the circumference of the ring waveguide 1603B. However, in some embodiments, one or more of the radial length of the sub-wavelength patterned structures within the outer radial portion 1603B1 and the radial length of the sub-wavelength patterned structures within the inner radial portion 1603B2 varies at different circumferential positions along the ring waveguide 1603B. The bus waveguide 1601A is configured as a solid structured strip-type waveguide that curves around a portion of the ring waveguide 1603A within the optical coupling region 1611A between the ring waveguide 1603A and the bus waveguide 1601A, in accordance with the curvature considerations discussed herein.

FIG. 16C shows a top view of an optical coupling configuration 1600C in which a ring waveguide 1603C is optically coupled to a bus waveguide 1601C within an optical coupling region 1611C, in accordance with some embodiments. An entire circumference of an inner radial portion 1603C1 of the ring waveguide 1603C is configured to have a sub-wavelength patterned structure (meta-material structure), in conjunction with a solid rib structure along an entire circumference of an outer radial portion 1603C2 of the ring waveguide 1603C. In some embodiments, a radial length of the sub-wavelength patterned structures within the inner radial portion 1603C1 is substantially uniform around the circumference of the ring waveguide 1603C, and the radial width of the outer radial portion 1603C2 is substantially uniform around the circumference of the ring waveguide 1603C. However, in some embodiments, one or more of the radial length of the sub-wavelength patterned structures within the inner radial portion 1603C1 and the radial width of the outer radial portion 1603C2 varies at different circumferential positions along the ring waveguide 1603C. The bus waveguide 1601C is configured as a solid structured strip-type waveguide that curves around a portion of the ring waveguide 1603C within the optical coupling region 1611C between the ring waveguide 1603C and the bus waveguide 1601C, in accordance with the curvature considerations discussed herein.

As mentioned above, in some embodiments, the radial length of the sub-wavelength patterned structures formed along the ring waveguide can vary at different locations along the circumference of the ring waveguide. In some embodiments, the radial length of the sub-wavelength patterned structures (also referred to as the depth or amplitude of the corrugation) is smoothly tapered from a solid core ring waveguide to almost an entirely sub-wavelength patterned ring waveguide, with the inner radial portion of the ring waveguide configured as a solid region around the full circumference of the ring waveguide. In some embodiments, having the inner radial portion of the ring waveguide configured as a solid region around the full circumference of the ring waveguide provides for compliance with design rules, such as minimum feature size.

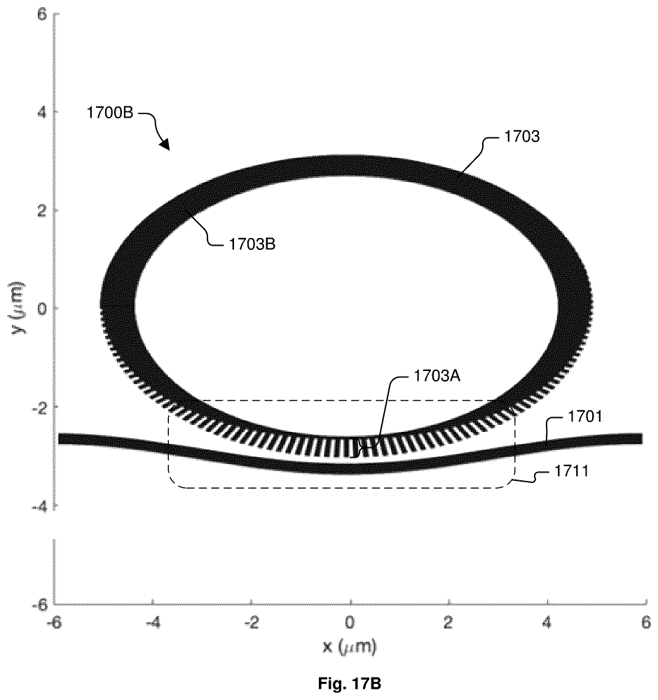

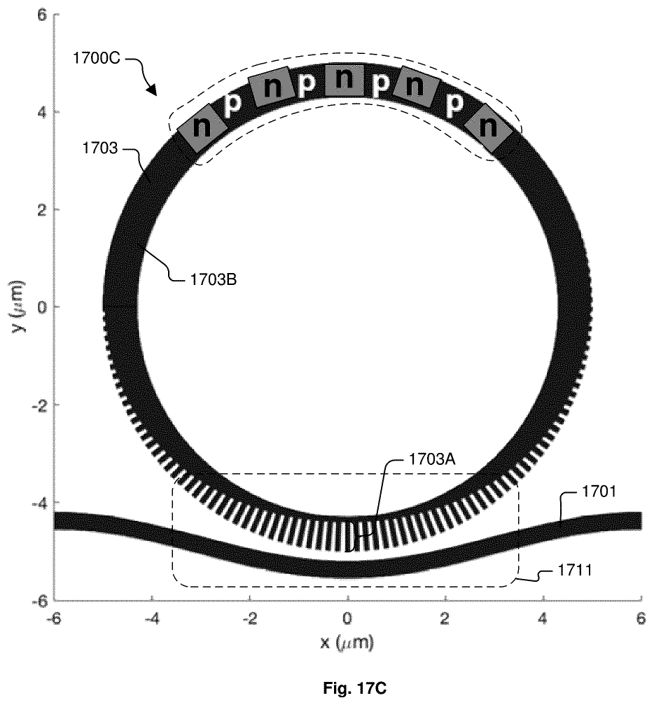

FIG. 17A shows a top view of an optical coupling configuration 1700A in which a ring waveguide 1703 is optically coupled to a bus waveguide 1701 within an optical coupling region 1711, in accordance with some embodiments. A portion (less than all) of the circumference of the ring waveguide 1703 that extend through the optical coupling region 1711 is configured to have a sub-wavelength patterned structure (meta-material structure) 1703A. A solid rib structure 1703B is formed along an entire inner circumference of the ring waveguide 1703. In some embodiments, a radial length of the sub-wavelength patterned structures 1703A varies in a tapered manner along a portion of the circumference of the ring waveguide 1703, such that the radial length of the sub-wavelength patterned structures 1703A reaches a maximum size at a location of closest approach of the ring waveguide 1703 to the bus waveguide 1701. Also, the radial length of the sub-wavelength patterned structures 1703A tapers (smoothly and monotonically decreases) from the maximum size to zero over a non-zero distance along the circumferential length of the ring waveguide 1703 in each direction away from the location of closest approach of the ring waveguide 1703 to the bus waveguide 1701. In some embodiments, the radial length of the sub-wavelength patterned structures 1703A tapers to zero at two circumferential locations along the ring waveguide 1703 outside of the optical coupling region 1711, in respective directions away from the location of closest approach of the ring waveguide 1703 to the bus waveguide 1701. The tapering of the radial length of the sub-wavelength patterned structures 1703A in this manner provided for efficient optical modulation by the ring waveguide 1703. The bus waveguide 1701 is configured as a solid structured strip-type waveguide that curves around a portion of the ring waveguide 1703 within the optical coupling region 1711 between the ring waveguide 1703 and the bus waveguide 1701, in accordance with the curvature considerations discussed herein.

FIG. 17B shows a top view of an optical coupling configuration 1700B that is a variation of the optical coupling configuration 1700A of FIG. 17A, in accordance with some embodiments. Specifically, in the optical coupling configuration 1700B, the ring waveguide 1703 is configured to have a larger bend radius within the portion of the circumference of the ring waveguide 1703 that extends through the optical coupling region 1711 and that has the sub-wavelength patterned structures (meta-material structure) 1703A. Also, in some embodiments, the bend radius of the ring waveguide 1703 is smaller at other circumferential locations along the ring waveguide 1703 in order to accommodate the larger bend radius within the portion of the circumference of the ring waveguide 1703 that extends through the optical coupling region 1711 and that has the sub-wavelength patterned structures (meta-material structure) 1703A. In the example optical coupling configuration 1700B, the bend radius (local curvature) of the ring waveguide 1703 is smoothly varied along the circumferential length of the ring waveguide 1703, as the corrugation strength of the sub-wavelength patterned structures 1703A is also varied along the circumferential length of the ring waveguide 1703, in order to keep the bend radius of the ring waveguide 1703 corresponding to the effective optical index, and in order to keep the bend radius of the ring waveguide 1703 at a size that can be supported locally without high bend radiation loss. The tapering of the radial length of the sub-wavelength patterned structures 1703A in conjunction with the larger bend radius of the ring waveguide 1703 within the optical coupling region 1711 helps compensate for weaker optical confinement provided by the sub-wavelength patterned structures 1703A, so as to keep bend loss in bounds.

FIG. 17C shows a top view of an optical coupling configuration 1700C that is a variation of the optical coupling configuration 1700A of FIG. 17A, in accordance with some embodiments. Specifically, the optical coupling configuration 1700C includes diode structures 1719. In some embodiments, a portion of the solid rib structure 1703B of the ring waveguide 1703 includes alternatingly positioned p-doped regions and n-doped regions to form the diode structures 1719 along the portion of the solid rib structure 1703B of the ring waveguide 1703. In some embodiments, the p-doped regions and n-doped regions are formed in physical contact with each other to form PN junction diodes. In some embodiments, the p-doped regions and n-doped regions are physical separated from each other with an intervening intrinsic material (silicon) to form P-I-N junction diodes. It should be understood that in various embodiments, any of the optical coupling configurations disclosed herein is configurable to include a number of diode structures and/or other active structures for various purposes.

The foregoing description of the embodiments has been provided for purposes of illustration and description, and is not intended to be exhaustive or limiting. Individual elements or features of a particular embodiment are generally not limited to that particular embodiment, but, where applicable, are interchangeable and can be used in a selected embodiment, even if not specifically shown or described. In this manner, one or more features from one or more embodiments disclosed herein can be combined with one or more features from one or more other embodiments disclosed herein to form another embodiment that is not explicitly disclosed herein, but rather that is implicitly disclosed herein. This other embodiment may also be varied in many ways. Such embodiment variations are not to be regarded as a departure from the disclosure herein, and all such embodiment variations and modifications are intended to be included within the scope of the disclosure provided herein.

Although some method operations may be described in a specific order herein, it should be understood that other operations may be performed in between method operations, and/or method operations may be adjusted so that they occur at slightly different times or simultaneously, or may be distributed in a system which allows the occurrence of the processing operations at various intervals associated with the processing, as long as the processing of the method operations are performed in a manner that provides for successful implementation of the method.

Although the foregoing embodiments have been described in some detail for purposes of clarity of understanding, it will be apparent that certain changes and modifications can be practiced within the scope of the appended claims. Accordingly, the embodiments disclosed herein are to be considered as illustrative and not restrictive, and are therefore not to be limited to just the details given herein, but may be modified within the scope and equivalents of the appended claims.

What is claimed is:

1. An optical coupling configuration, comprising:
a first waveguide having a core region and a first side region that extends laterally outward from a first side of the core region in a first direction that is perpendicular to a lengthwise centerline of the core region, wherein a vertical thickness of the first side region is smaller than a vertical thickness of the core region;
a second waveguide positioned within an evanescent optical coupling distance of the core region of the first waveguide, the second waveguide positioned on a second side of the core region of the first waveguide opposite from the first side of the core region of the first waveguide;
a diode formed within the first side region of the first waveguide, the diode including an n-doped region and a p-doped region, wherein both the n-doped region and the p-doped region are physically separated from the core region of the first waveguide; and
an electrically conductive structure in direct electrical connection with each of the n-doped region and the p-doped region so as to form an electrical short between the n-doped region and the p-doped region.

2. The optical coupling configuration as recited in claim 1, wherein there is no diode formed within the second side region of the first waveguide within an optical coupling region between the first waveguide and the second waveguide.

3. The optical coupling configuration as recited in claim 1, wherein the first waveguide is formed of silicon and the second waveguide is formed of silicon.

4. The optical coupling configuration as recited in claim 1, wherein the first waveguide is formed of silicon nitride and the second waveguide is formed of silicon.

5. The optical coupling configuration as recited in claim 1, wherein the first waveguide has a full-rib structure.

6. The optical coupling configuration as recited in claim 1, wherein the first waveguide has a half-rib structure.

7. The optical coupling configuration as recited in claim 1, wherein the first waveguide has a substantially linear shape within an optical coupling region between the first waveguide and the second waveguide, and wherein the second waveguide has a substantially linear shape within the optical coupling region.

8. The optical coupling configuration as recited in claim 1, wherein the first waveguide has a substantially linear shape within an optical coupling region between the first waveguide and the second waveguide, and wherein the second waveguide has a curved shape within the optical coupling region.

9. The optical coupling configuration as recited in claim 8, wherein the first waveguide includes a second side region that extends laterally outward from the second side of the core region of the first waveguide in a second direction that is opposite of the first direction, and wherein the second waveguide includes a core region and a first side region that extends laterally outward from the core region of the second waveguide in a direction toward the first waveguide, wherein the second side region of the first waveguide and the first side region of the second waveguide merge together within the optical coupling region.

10. The optical coupling configuration as recited in claim 8, wherein the first waveguide includes a second side region that extends laterally outward from the second side of the core region of the first waveguide in a second direction that is opposite of the first direction, and wherein the second waveguide includes a core region and a first side region that extends laterally inward from the core region of the second waveguide in a direction away from the first waveguide, wherein the second side region of the first waveguide has a lateral width as measured in the second direction that tapers from a non-zero full-size width at a first location outside of the optical coupling region to a zero width at a location of closest approach of the core region of the first waveguide to the core region of the second waveguide within the optical coupling region.

11. The optical coupling configuration as recited in claim 10, wherein the lateral width of the second side region of the first waveguide tapers from the non-zero full-size width at a second location outside of the optical coupling region to the zero width at the location of closest approach of the core region of the first waveguide to the core region of the second waveguide within the optical coupling region.

12. The optical coupling configuration as recited in claim 1, wherein the diode generates a built-in electric field that extends across the core region of the first waveguide.

13. The optical coupling configuration as recited in claim 1, wherein a portion of the first side region of the first waveguide is an intrinsic material within a P-I-N junction of the diode.

14. The optical coupling configuration as recited in claim 1, further comprising:
a plurality of diodes formed within the first side region of the first waveguide, said diode being one of the plurality of diodes, each diode in the plurality of diodes including a respective n-doped region and a respective p-doped region, wherein each of the respective n-doped regions and the respective p-doped regions is physically separated from the core region of the first waveguide; and
a plurality of electrically conductive structures respectively formed to electrically short the respective n-doped region with the respective p-doped region of each of the plurality of diodes, said electrically conductive structure being one of the plurality of electrically conductive structures.

15. The optical coupling configuration as recited in claim 14, wherein the n-doped regions and the p-doped regions are positioned in an alternating sequence along the first side region of the first waveguide.

16. The optical coupling configuration as recited in claim 15, wherein adjacently positioned ones of the n-doped regions and the p-doped regions are formed in physical contact with each other.

17. The optical coupling configuration as recited in claim 15, wherein adjacently positioned ones of the n-doped regions and the p-doped regions are physically separated from each other.

18. The optical coupling configuration as recited in claim 17, further comprising:
a plurality of insulator spacers formed to electrically and physically separate the n-doped region from the p-doped region within respective ones of the plurality of diodes.

19. The optical coupling configuration as recited in claim 14, wherein each of the plurality of electrically conductive structures is formed as a respective region of silicide.

20. The optical coupling configuration as recited in claim 14, wherein each of the plurality of electrically conductive structures is formed as a respective metal structure.

21. The optical coupling configuration as recited in claim 1, further comprising:
a plurality of diodes formed within the first side region of the first waveguide, said diode being one of the plurality of diodes, each diode in the plurality of diodes including a respective n-doped region and a respective p-doped region, wherein each of the respective n-doped regions and the respective p-doped regions is physically separated from the core region of the first waveguide,
wherein the electrically conductive structure is formed to electrically short all of the n-doped regions and all of the p-doped regions of the plurality of diodes.

22. The optical coupling configuration as recited in claim 1, wherein the first waveguide is a bus waveguide, and wherein the second waveguide is a ring waveguide.

23. An optical coupling configuration, comprising:
a first waveguide having a core region and a first side region that extends laterally outward from a first side of the core region in a first direction that is perpendicular to a lengthwise centerline of the core region, wherein the first side region is formed as a meta-material;
a second waveguide positioned within an evanescent optical coupling distance of the core region of the first waveguide, the second waveguide positioned on a second side of the core region of the first waveguide opposite from the first side of the core region of the first waveguide;
a diode formed within the first side region of the first waveguide, the diode including an n-doped region and a p-doped region, wherein both the n-doped region and the p-doped region are physically separated from the core region of the first waveguide; and
an electrically conductive structure in direct electrical connection with each of the n-doped region and the p-doped region so as to form an electrical short between the n-doped region and the p-doped region.

24. The optical coupling configuration as recited in claim 23, wherein the meta-material includes multiple fingers of a same material as the core region of the first waveguide, each of the multiple fingers extending in the first direction linearly away from the core region of the first waveguide, each of the multiple fingers has a width as measured in a second direction that is perpendicular to the first direction, wherein adjacent ones of the multiple fingers are positioned apart from each other by a pitch as measured in the second direction such that a side-to-side spacing between adjacent ones of the multiple fingers is less than a wavelength of light propagating through the core region of the first waveguide.

25. An optical coupling configuration, comprising:
a first waveguide having a core region and a first side region that extends laterally outward from a first side of the core region in a first direction that is perpendicular to a lengthwise centerline of the core region, wherein a vertical thickness of the first side region is smaller than a vertical thickness of the core region;
a second waveguide positioned within an evanescent optical coupling distance of the core region of the first waveguide, the second waveguide positioned on a second side of the core region of the first waveguide opposite from the first side of the core region of the first waveguide; and
a doped region formed within the first side region of the first waveguide and through an optical coupling region between the core region of the first waveguide and the second waveguide, the doped region physically separated from the core region of the first waveguide, the doped region having a dopant concentration sufficiently high to remove free-carriers from within the first waveguide within the optical coupling region.
